(19) United States
(12) Patent Application Publication
(10) Pub. No.: US 2026/0143519 A1
(43) Pub. Date: May 21, 2026

(54) MESSAGE TRANSMISSION METHOD AND APPARATUS, MESSAGE RECEIVING METHOD AND APPARATUS, TERMINAL, AND NETWORK-SIDE DEVICE

(71) Applicant: VIVO MOBILE COMMUNICATION CO., LTD., Dongguan (CN)

(72) Inventors: Zhipeng LIN, Dongguan (CN); Yong WANG, Dongguan (CN); Wei JIANG, Dongguan (CN)

(73) Assignee: VIVO MOBILE COMMUNICATION CO., LTD., Dongguan (CN)

(21) Appl. No.: 19/443,749

(22) Filed: Jan. 8, 2026

Related U.S. Application Data
(63) Continuation of application No. PCT/CN2024/104382, filed on Jul. 9, 2024.

(30) Foreign Application Priority Data
Jul. 10, 2023 (CN) 202310840176.7

(51) Int. Cl. H04W 74/00

(52) U.S. Cl. CPC H04W 74/006

(57) ABSTRACT

The present application discloses a message transmission method and apparatus, a message receiving method and apparatus, a terminal, and a network-side device. The message transmission method in embodiments of the present application includes: transmitting, by a terminal, a target message, the target message being used for at least one of the following: indicating repetition-related functionality of a downlink channel supported by the terminal; and requesting downlink transmission that is corresponding to the repetition-related functionality of the downlink channel and that is transmitted to the terminal, where the downlink channel includes at least one of the following: a common PDCCH and a common PDSCH.

### CROSS-REFERENCE TO RELATED APPLICATIONS

This application is a continuation application of PCT International Application No. PCT/CN2024/104382 filed on Jul. 9, 2024, which claims priority to Chinese Patent Application No. 202310840176.7 filed in China on Jul. 10, 2023, which is incorporated herein by reference in its entirety.

### TECHNICAL FIELD

The present application relates to the field of communication technology, and in particular, to a message transmission method and apparatus, a message receiving method and apparatus, a terminal, and a network-side device.

### BACKGROUND

In some scenarios or states, a terminal needs to receive some common downlink channels, such as a common physical downlink control channel (PDCCH) and a common physical downlink shared channel (PDSCH). In some related technologies, the common downlink channels typically support only a single transmission, resulting in a lower success rate for the terminal in receiving the downlink channels, which leads to poor service performance of the terminal.

### SUMMARY

Embodiments of the present application provide a message transmission method and apparatus, a message receiving method and apparatus, a terminal, and a network-side device.

In a first aspect, there is provided a message transmission method, including:
transmitting, by a terminal, a target message, the target message being used for at least one of the following:
indicating repetition-related functionality of a downlink channel supported by the terminal; and
requesting downlink transmission that is corresponding to the repetition-related functionality of the downlink channel and that is transmitted to the terminal,
where the downlink channel includes at least one of the following:
a common PDCCH and a common PDSCH.

In a second aspect, there is provided a message receiving method, including:
receiving, by a network-side device, a target message transmitted by a terminal, the target message being used for at least one of the following:
indicating repetition-related functionality of a downlink channel supported by the terminal; and
requesting downlink transmission that is corresponding to the repetition-related functionality of the downlink channel and that is transmitted to the terminal,
where the downlink channel includes at least one of the following:
a common PDCCH and a common PDSCH.

In a third aspect, there is provided a message transmission apparatus, including:
a transmission module configured to transmit a target message, the target message being used for at least one of the following:
indicating repetition-related functionality of a downlink channel supported by the terminal; and
requesting downlink transmission that is corresponding to the repetition-related functionality of the downlink channel and that is transmitted to the terminal,
where the downlink channel includes at least one of the following:
a common PDCCH and a common PDSCH.

In a fourth aspect, there is provided a message receiving apparatus, including:
a receiving module configured to receive a target message transmitted by a terminal, the target message being used for at least one of the following:
indicating repetition-related functionality of a downlink channel supported by the terminal; and
requesting downlink transmission that is corresponding to the repetition-related functionality of the downlink channel and that is transmitted to the terminal,
where the downlink channel includes at least one of the following:
a common PDCCH and a common PDSCH.

In a fifth aspect, there is provided a terminal including a processor and a memory, the memory storing programs or instructions executable by the processor, and the programs or instructions, when executed by the processor, implementing steps of the message transmission method according to the embodiments of the present application.

In a sixth aspect, there is provided a terminal including a processor and a communication interface, the communication interface being configured to transmit a target message used for at least one of the following: indicating repetition-related functionality of a downlink channel supported by the terminal; and requesting downlink transmission that is corresponding to the repetition-related functionality of the downlink channel and that is transmitted to the terminal, where the downlink channel includes at least one of the following: a common PDCCH and a common PDSCH.

In a seventh aspect, there is provided a network-side device including a processor and a memory, the memory storing programs or instructions executable by the processor, and the programs or instructions, when executed by the processor, implementing steps of the message receiving method according to the embodiments of the present application.

In an eighth aspect, there is provided a network-side device, including a processor and a communication interface, the communication interface being configured to receive a target message transmitted by a terminal, and the target message being used for at least one of the following: indicating repetition-related functionality of a downlink channel supported by the terminal; and requesting downlink transmission that is corresponding to the repetition-related functionality of the downlink channel and that is transmitted to the terminal, where the downlink channel includes at least one of the following: a common PDCCH and a common PDSCH.

In a ninth aspect, there is provided a readable storage medium having programs or instructions stored therein, the programs or instructions, when executed by a processor, implementing steps of the message transmission method according to the embodiments of the present application, or implementing steps of the message receiving method according to the embodiments of the present application.

In a tenth aspect, there is provided a wireless communication system including a terminal and a network-side device, the terminal being configured to perform steps of the message transmission method according to the embodiments of the present application, and the network-side device being configured to perform steps of the message receiving method according to the embodiments of the present application.

In an eleventh aspect, there is provided a chip including a processor and a communication interface, the communication interface being coupled to the processor, and the processor being configured to run programs or instructions to implement the message transmission method according to the embodiments of the present application, or to implement the message receiving method according to the embodiments of the present application.

In a twelfth aspect, there is provided a computer program/program product stored in a storage medium, the program/program product being executed by at least one processor to implement steps of the message transmission method according to the embodiments of the present application, and the program/program product being executed by at least one processor to implement steps of the message receiving method according to the embodiments of the present application.

### BRIEF DESCRIPTION OF THE DRAWINGS

FIG. 1 is a block diagram of a wireless communication system that can be applied to an embodiment of the present application;

FIG. 2 is a flowchart of a message transmission method according to an embodiment of the present application;

FIG. 3 is a flowchart of a message receiving method according to an embodiment of the present application;

FIG. 4 is a structural diagram of a message transmission apparatus according to an embodiment of the present application;

FIG. 5 is a structural diagram of a message receiving apparatus according to an embodiment of the present application;

FIG. 6 is a structural diagram of a communication device according to an embodiment of the present application;

FIG. 7 is a structural diagram of a terminal according to an embodiment of the present application; and

FIG. 8 is a structural diagram of a network-side device according to an embodiment of the present application.

### DETAILED DESCRIPTION

Technical solutions in embodiments of the present application are clearly described below with reference to the drawings in the embodiments of the present application. It is apparent that the described embodiments are merely part of rather than all of the embodiments of the present application.

The terms “first”, “second”, and the like in the present application are used to distinguish similar objects and are not intended to describe any specific order or sequence. It is to be understood that such terms used herein are interchangeable as appropriate, so that the embodiments of the present application can be implemented in sequences other than those illustrated or described herein. The objects distinguished by “first”, “second”, and the like are generally of the same type and are not limited in number, for example, a first object may be a single object or multiple objects. In addition, the term “or” in the present application denotes at least one of the connected objects. For example, “A or B” encompasses three scenarios: scenario one: including A but not B; scenario two: including B but not A; and scenario three: including both A and B. The character “/” generally denotes an “or” relationship between the associated objects.

The term “indicate” in the present application may refer to either a direct indication (i.e., an explicit indication) or an indirect indication (i.e., an implicit indication). The direct indication can be understood as a sender explicitly informing a receiver of specific information, operations to be performed, requested results, or the like in the transmitted indication. The indirect indication can be understood as the receiver determining, according to the indication transmitted by the sender, the corresponding information, or making a determination and determining, based on the determination, the operations to be performed or the requested results.

It is to be noted that, the technology described in the embodiments of the present application is not limited to a long term evolution (LTE)/LTE-advanced (LTE-A) system, and may be further applied to other wireless communication systems, such as a code division multiple access (CDMA) system, a time division multiple access (TDMA) system, a frequency division multiple access (FDMA) system, an orthogonal frequency division multiple access (OFDMA) system, a single-carrier frequency division multiple access (SC-FDMA) system, or other systems. The terms “system” and “network” in the embodiments of the present application are often used interchangeably. The described technology can be applied not only to the systems and radio technologies described above, but also to other systems and radio technologies. The following description illustrates a new radio (NR) system for exemplary purposes, and NR terminology is used in most of the subsequent description. However, these technologies may be applied to systems other than NR systems, such as 6^{th} generation (6G) communication systems.

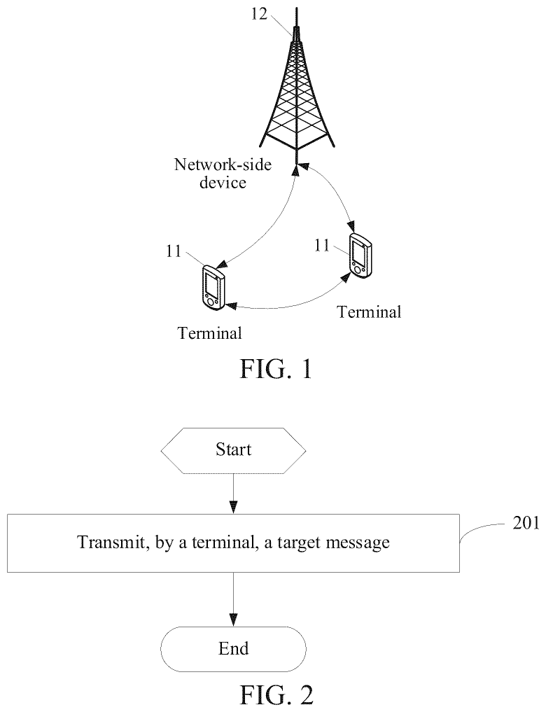

FIG. 1 shows a block diagram of a wireless communication system that can be applied to an embodiment of the present application. The wireless communication system includes a terminal 11 and a network-side device 12. The terminal 11 may be a terminal-side device, such as a mobile phone, tablet personal computer, laptop computer, notebook computer, personal digital assistant ( ) handheld computer, netbook, ultra-mobile personal computer (UMPC), mobile Internet device (MID), augmented reality (AR) device, virtual reality (VR) device, robot, wearable device, flight vehicle, vehicle user equipment (VUE), shipborne device, pedestrian user equipment (PUE), smart home device (home equipment with wireless communication capabilities, such as a refrigerator, television, washing machine, or furniture), game console, personal computer (PC), Automated Teller Machine, or self-service terminal. The wearable devices include smart watches, smart wristbands, smart earphones, smart glasses, smart jewelry (such as smart bracelets, smart bangles, smart rings, smart necklaces, smart anklets, and smart foot chains), smart bands, smart clothing, and the like. The vehicle user equipment may be referred to as a vehicle terminal, vehicle controller, vehicle module, vehicle component, vehicle chip, vehicle unit, or the like. It is to be noted that the embodiments of the present application do not limit the specific type of the terminal 11. The network-side device 12 may include an access network device or a core network device, where the access network device may be referred to as a radio access network (RAN) device, a radio access network function, or a radio access network unit. The access network device may include a base station, a wireless local area network (WLAN) access point (AP), a wireless fidelity (WiFi) node, or the like. The base station may be referred to as node B (NB), evolved node B (eNB), the next generation node B (gNB), new radio node B (NR Node B), access point, relay base station (RBS), serving base station (SBS), base transceiver station (BTS), radio base station, radio transceiver, basic service set (BSS), extended service set (ESS), home node B (HNB), home evolved node B, transmission reception point (TRP), or any other suitable term in the field, provided the same technical effect is achieved. The base station is not limited to a specific technical term. It is to be noted that, in the embodiments of the present application, the base station in an NR system is used merely as an example for illustration, and the specific type of the base station is not limited.

The core network device may include, but is not limited to, at least one of the following: core network nodes, core network functions, mobility management entity (MME), access and mobility management function (AMF), session management function (SMF), user plane function (UPF), policy control function (PCF), policy and charging rules function (PCRF), edge application server discovery function (EASDF), unified data management (UDM), unified data repository (UDR), home subscriber server (HSS), centralized network configuration (CNC), network repository function (NRF), network exposure function (NEF), local NEF (L-NEF), binding support function (BSF), application function (AF), and the like. It is to be noted that the core network device in the NR system is used only as an example for description in the embodiments of the present application, and a specific type of core network device is not limited.

In some embodiments, a random access procedure may be a contention-based random access process or a contention-free random access process. The random access procedure may be a four-step random access procedure (also referred to as Type-1 (Type-1) random access procedure) or a two-step random access procedure (also referred to as Type-2 (Type-2) random access procedure).

In the contention-based four-step random access procedure, the terminal first transmits Message 1 (Msg1) to the network, which includes a preamble. After detecting the preamble, the network transmits the Message 2 (Msg2)/random access response (RAR) message, which includes identifiers of the detected preamble by the network and the uplink radio resources allocated for the terminal to transmit Message 3 (Msg3). After receiving Msg2, the terminal confirms that at least one of the identifiers of the preamble carried in Msg2 matches the identifier of the preamble transmitted by the terminal, and then, according to the resources indicated in the RAR, transmits Msg3, which includes contention resolution information. Upon receiving Msg3, the network transmits Message 4 (Msg4), which includes the contention resolution information. The terminal receives Msg4 and determines that the resolution information is consistent with what the terminal transmitted in Msg3, i.e., completing the four-step random access procedure.

The network includes uplink grant (UL grant) information in the RAR to indicate the physical uplink shared channel (PUSCH) scheduling information for Msg3, and also includes the random access preamble identifier (RAPID), temporary cell-radio network temporary identifier (TC-RNTI), timing advance (TA), and the like. If the network does not receive Msg3 PUSCH, it can schedule the retransmission of Msg3 PUSCH on the physical downlink control channel (PDCCH) using TC-RNTI scrambling.

In a contention-based random access procedure, different terminals randomly select preambles for transmission. As a result, different terminals may select the same preamble for transmission on the same time-frequency radio resources (such as random access occasion (RO) resources), which can be understood as a preamble collision between terminals. In this case, different terminals may receive the same RAR and may perform Msg3 PUSCH transmission according to the scheduling information in the UL grant included in the RAR. In some related technologies, since repetition of Msg3 PUSCH is not supported, the network can only decode the PUSCH (including contention resolution information) transmitted by one terminal on a Msg3 PUSCH scheduling resource. Therefore, the network may include the contention resolution information received in Msg3 within Msg4. If the contention resolution information in Msg4 received by the terminal matches the contention resolution information transmitted by the terminal in Msg3 PUSCH, the terminal considers the contention resolution successful. If it does not match, the contention resolution is considered unsuccessful.

If the contention resolution is unsuccessful, the terminal reselects the RACH transmission resources and performs transmission on the physical random access channel (PRACH) for the next random access attempt.

In some embodiments, the first step of the two-step random access procedure (2-step RACH) involves the terminal transmitting Message A (MsgA) to the network side. After receiving MsgA, the network side transmits Message B (MsgB) to the terminal. If the terminal does not receive MsgB within a specified time, the terminal may increment the counter that tracks the number of MsgA transmissions and retransmit MsgA. If the counter that tracks the number of MsgA transmissions reaches a threshold, the terminal may switch from the two-step random access procedure to the four-step random access procedure. MsgA includes the MsgA preamble part and the MsgA PUSCH part. The preamble part is transmitted on the RO used for the two-step random access procedure, while the PUSCH part is transmitted on the MsgA PUSCH resources associated with the MsgA preamble and the RO. The MsgA PUSCH resources are a set of PUSCH resources configured for each PRACH slot, including time-frequency resources and demodulation reference signal (DMRS) resources.

In some embodiments, during the random access procedure, the reception of scheduling information for Msg2/MsgB/Msg4 on the physical downlink shared channel (PDSCH) requires being within a window, the size of which is configured by the network.

For Msg2, the window described above starts from the first symbol of the control resource set (CORESET) within the Type 1 PDCCH common search space set (Type1-PDCCH CSS set) following the PRACH transmission. For MsgB, the window described above starts from the first symbol of the CORESET within the Type1-PDCCH CSS set following the PUSCH (MsgA PUSCH part) resource corresponding to the PRACH (MsgA PRACH part) transmission. For Msg3, the above window is actually controlled by the random access contention resolution timer (ra-ContentionResolutionTimer), which starts or restarts after the transmission of Msg3 (or the last repetition of Msg3 if Msg3 repetition is supported).

In some embodiments, the CORESET is a set of time-domain and frequency-domain resources for control information. CORESET #0 is a special CORESET, typically used for scheduling the transmission of a system information block (SIB) 1 on the PDCCH. The configuration information of CORESET #0 and the configuration information for the listening occasion of the Type0-PDCCH common search space (CSS) are carried by the associated cell defining synchronization signal block (CD-SSB). The main function of CORESET #0 is to define the time and frequency resources of the Type0-PDCCH CSS and the size of the listening occasion for the Type0-PDCCH CSS.

A message transmission method and apparatus, a message receiving method and apparatus, a terminal, and a network-side device according to the embodiments of the present application are described in detail below with reference to the drawings, along with some embodiments and application scenarios thereof.

Referring to FIG. 2, FIG. 2 is a flowchart of a message transmission method according to an embodiment of the present application. As shown in FIG. 2, the method includes the following steps:
Step 201: A terminal transmits a target message, the target message being used for at least one of the following:
indicating repetition-related functionality of a downlink channel supported by the terminal; and
requesting downlink transmission that is corresponding to the repetition-related functionality of the downlink channel and that is transmitted to the terminal,
where the downlink channel includes at least one of the following:
a common PDCCH and a common PDSCH.

The terminal transmitting a target message described above may involve transmitting the target message to the network-side device.

The repetition-related functionality of the downlink channel described above refers to the related function of downlink channel repetition, which may be referred to as the repetition-related capability of the downlink channel, or the downlink channel repetition capability.

The repetition-related functionality of the downlink channel supported by the terminal indicates that the terminal supports the repetition of the uplink channel described above, that is, the terminal supports receiving repetitions of the downlink channel. The terminal's support for receiving repetitions of the downlink channel indicates that the terminal has the capability to receive the common PDCCH/PDSCH repetition.

The requesting downlink transmission that is corresponding to the repetition-related functionality of the downlink channel and that is transmitted to the terminal described above can be understood as the terminal requesting the network-side device to transmit the above downlink channel according to the repetition-related functionality of the downlink channel. In particular, the terminal requests the network to retransmit the common PDCCH/PDSCH, and the above request may or may not include information such as the number of repetitions requested. After receiving the above request, the network-side device performs repetition of the downlink channel, i.e., retransmits the downlink channel to the terminal.

In some implementations, in a case that the above target message indicates the repetition-related functionality of the downlink channel supported by the terminal, it represents requesting downlink transmission that is corresponding to the repetition-related functionality of the downlink channel and that is transmitted to the terminal by the network-sided device.

In some implementations, in a case that the target message requests downlink transmission that is corresponding to the repetition-related functionality of the downlink channel and that is transmitted to the terminal, it indicates the repetition-related functionality of the downlink channel supported by the terminal.

In some implementations, the above target message may indicate whether the above terminal supports the repetition-related functionality of the downlink channel, such as whether the terminal has the capability to receive the corresponding common PDSCH/PDCCH repetition. Alternatively, the above target message may indicate whether the terminal requests downlink transmission that is corresponding to the repetition-related functionality of the downlink channel and that is transmitted to the terminal, or whether the terminal has the capability to request downlink transmission that is corresponding to the repetition-related functionality of the downlink channel and that is transmitted to the terminal, such as whether the terminal has the capability to request the network to perform repetition of the common PDSCH/PDCCH under certain conditions.

In the embodiments of the present application, the above steps enable support for repetition of at least one of the common PDCCH or common PDSCH, thereby enhancing a success rate of the terminal receiving the downlink channel and enhancing the service performance of the terminal.

In this embodiment, after transmitting the above target message, the network-side device transmits the repetition of the downlink channel to the terminal based on the target message, and the terminal receives the repetition of the uplink channel.

As an optional implementation, the common PDCCH includes at least one of the following:
a PDCCH to be received by the terminal before entering a connected state; and
a PDCCH transmitted on a common PDCCH resource.

The PDCCH to be received by the terminal before entering a connected state described above may include at least one of the following:
a PDCCH scheduling the PDSCH to be received by the terminal before entering the connected state;
a PDCCH scheduling the Msg3 PUSCH retransmission; and
a PDCCH scheduling Msg5.

In some implementations, the above common PDCCH may specifically include at least one of the following:

SIB1 PDCCH, other system information (OSI) PDCCH, Msg2 PDCCH, Msg4 PDCCH, MsgB PDCCH, Paging PDCCH, and PDCCH scheduling Msg3 retransmission.

The above PDCCH transmitted on the common PDCCH resources may be one or more PDCCHs transmitted on the common PDCCH resources, such as one or more PDCCHs transmitted by CORESET #0, and may be PDCCHs transmitted by the Type0/0A/1/2 common search space set (Common Search Space Set), such as the SIB1 PDCCH, OSI PDCCH, Msg2 PDCCH, Msg4 PDCCH, MsgB PDCCH, Paging PDCCH, and the PDCCH scheduling the Msg3 retransmission. Additionally, the above common PDCCH resources refer to CORESET resources that support CSS, which may be CORESET #0 or other CORESETs. The CSS includes the Type0/0A/1/2 CSS sets and the like. Additionally, the PDCCH transmitted on the CORESET resources associated with the CSS is also referred to as the broadcast PDCCH.

As an optional implementation, the common PDSCH includes at least one of the following:
a PDSCH to be received by the terminal before entering the connected state.

The PDSCH to be received by the terminal before entering the connected state may include at least one of the following:
Msg2 PDSCH, MsgB PDSCH, Msg4 PDSCH, and Paging PDSCH.

That is, the common PDSCH may specifically include at least one of the following:
Msg2 PDSCH, MsgB PDSCH, and Msg4 PDSCH.

In this implementation, repetition of at least one of Msg2 PDSCH, MsgB PDSCH, Msg4 PDSCH, and Paging PDSCH can be achieved, thereby enhancing Msg2 PDSCH, MsgB PDSCH, Msg4 PDSCH, and Paging PDSCH, which can enhance the random access performance and the paging performance of the terminal.

In some implementations, the repetition of the common PDCCH/PDSCH described above may be referred to as common PDCCH/PDSCH repetition, such as for the downlink control and data channels related to Msg2/MsgB/Msg4, where the repetition can be referred to as Msg2/MsgB/Msg4 PDSCH/PDCCH repetition. The Msg2/MsgB/Msg4 PDSCH repetition herein can also be abbreviated as Msg2/MsgB/Msg4 repetition.

As an optional implementation, the target message includes at least one of the following:
a physical random access channel (PRACH), Msg1, Msg3 PUSCH, MsgA, MsgA PUSCH, and a message transmitted by the terminal in the connected state.

The messages transmitted by the terminal in the connected state described above refer to the messages transmitted by the terminal after entering the connected state.

The above target message may indicate, either implicitly or explicitly, the repetition-related functionality of the downlink channel supported by the terminal, or request downlink transmission that is corresponding to the repetition-related functionality of the downlink channel and that is transmitted to the terminal.

In some implementations, the PRACH is used for the indication/request through at least one of the following:
a time-domain resource of the PRACH, a frequency-domain resource of the PRACH, a configuration index of the PRACH, a sequence of the PRACH, a scrambling sequence of a sequence of the PRACH, a format of the PRACH, and whether the PRACH performs repetition.

The indication includes: indicating the repetition-related functionality of the downlink channel supported by the terminal, and the request includes: requesting downlink transmission that is corresponding to the repetition-related functionality of the downlink channel and that is transmitted to the terminal.

The above PRACH may include Msg1 PRACH or MsgA PRACH.

In this implementation, multiple resources, indexes, sequences, and formats can be pre-configured. These resources, indexes, sequences, and formats correspond to the execution or non-execution of the above request or indication. In this way, the terminal can implement the above indication or request by selecting different resources, indexes, sequences, and formats when transmitting the PRACH. For example, a set of preamble sequence indexes (or other factors described above) may be predefined, where the PRACH corresponding to a specific preamble sequence index implicitly indicates that one or more of the subsequent common PDCCH/PDSCH transmissions may be retransmitted, i.e., implementing the above indication or request.

Additionally, whether the PRACH performs repetition described above may be that when the terminal supports PRACH repetition, the terminal may support receiving one or more subsequent common PDCCH/PDSCH repetitions, i.e., implementing the above indication or request.

In the above implementation, the indication or request can be implemented without introducing additional messages, thereby saving transmission resources.

In some implementations, the MsgA PUSCH is used for the indication/request through at least one of the following:
information carried by the MsgA PUSCH, a time-domain resource of the MsgA PUSCH, a frequency-domain resource of the MsgA PUSCH, a demodulation reference signal (DMRS) resource of the MsgA PUSCH, a group in which the MsgA PUSCH is located, and whether the MsgA PUSCH performs repetition.

The indication includes: indicating the repetition-related functionality of the downlink channel supported by the terminal, and the request includes: requesting downlink transmission that is corresponding to the repetition-related functionality of the downlink channel and that is transmitted to the terminal.

In this implementation, multiple resources or groups can be pre-configured. These resources or groups correspond to the execution or non-execution of the above request or indication. In this way, the terminal can implement the above indication or request by selecting different resources or groups when transmitting the MsgA PUSCH. For example, multiple sets of MsgA PUSCH resources can be independently configured for terminals that support common PDCCH/PDSCH repetition and for terminals that do not support common PDCCH/PDSCH repetition. The network determines whether a terminal supports common PDCCH/PDSCH repetition functionality according to the MsgA PUSCH resources used by the detected terminal, i.e., implementing the above indication or request. For another example, in the MsgA configuration of the two-step random access (2-step RACH), two sets of PUSCH transmission occasions (PO) are configured: PO group A and PO group B. PO group A is used by terminals that support common PDCCH/PDSCH repetition, while PO group B is used by terminals that do not support common PDCCH/PDSCH repetition. The network determines whether the terminal supports receiving or requesting PDCCH/PDSCH repetition by detecting the PUSCH on the two PO groups, i.e., implementing the above indication or request.

In some implementations, the 2-step RACH does not involve the transmission of Msg4. However, when the 2-step RACH falls back (fallback) or switches to the four-step random access (4-step RACH), the corresponding MsgA PUSCH transmission is still performed. In this case, the MsgA PUSCH may be used to indicate the repetition capability of the corresponding Msg4 PDCCH/PDSCH.

Additionally, whether the MsgA PUSCH performs repetition described above may be that when the terminal supports MsgA PUSCH, the terminal may support receiving one or more subsequent common PDCCH/PDSCH repetitions, i.e., implementing the above indication or request.

In the above implementation, the indication or request can be implemented without introducing additional messages, thereby saving transmission resources.

In some implementations, the MsgA is used for the indication/request through at least one of the following:
a time-domain resource of the MsgA, a frequency-domain resource of the MsgA, and a DMRS resource of the MsgA.

The indication includes: indicating the repetition-related functionality of the downlink channel supported by the terminal, and the request includes: requesting downlink transmission that is corresponding to the repetition-related functionality of the downlink channel and that is transmitted to the terminal.

In this implementation, multiple resources or groups can be pre-configured. These resources or groups correspond to the execution or non-execution of the above request or indication. In this way, the terminal can implement the above indication or request by selecting different resources or groups when transmitting MsgA. For example, two sets of MsgA resources can be independently configured, with one set allocated to terminals supporting common PDCCH/PDSCH repetition and the other set to terminals that do not support common PDCCH/PDSCH repetition. The network determines the terminal's common PDCCH/PDSCH repetition capability according to the MsgA resources used by the detected terminal, i.e., implementing the above indication or request.

In the above implementation, the indication or request can be implemented without introducing additional messages, thereby saving transmission resources.

In some implementations, the Msg3 PUSCH is used for the indication/request through at least one of the following:
information carried by the Msg3 PUSCH, a time-domain resource of the Msg3 PUSCH, a frequency-domain resource of the Msg3 PUSCH, a DMRS resource of the Msg3 PUSCH, a payload size of the Msg3 PUSCH, and whether the Msg3 PUSCH performs repetition.

The indication includes: indicating the repetition-related functionality of the downlink channel supported by the terminal, and the request includes: requesting downlink transmission that is corresponding to the repetition-related functionality of the downlink channel and that is transmitted to the terminal.

The above information carried in the above Msg3 PUSCH may be indicated by reusing existing fields, introducing new fields, or using the logical channel identifier (logical channel ID).

In this implementation, multiple resources and payload sizes can be pre-configured. These resources and payload sizes correspond to the execution or non-execution of the above request or indication. In this way, the terminal can implement the above indication or request by selecting different resources or payload sizes when transmitting the Msg3 PUSCH. For example, two different Msg3 PUSCH payload sizes (e.g., Preamble group A and Preamble group B) can be independently configured, with one size used by terminals that support common PDCCH/PDSCH repetition and the other used by terminals that do not support common PDCCH/PDSCH repetition. The network determines the terminal's common PDCCH/PDSCH repetition capability according to the payload size used by the detected terminal, i.e., implementing the above indication or request.

Additionally, whether the Msg3 PUSCH performs repetition described above may be that when the terminal supports Msg3 PUSCH, the terminal may support receiving one or more subsequent common PDCCH/PDSCH repetitions, i.e., implementing the above indication or request.

In the above implementation, the indication or request can be implemented without introducing additional messages, thereby saving transmission resources.

In some implementations, the Msg1 is used to indicate the payload size of the Msg3 PUSCH or whether the Msg3 PUSCH performs repetition, where the payload size of the Msg3 PUSCH or whether the Msg3 PUSCH performs repetition is used for indication or request.

The indication includes: indicating the repetition-related functionality of the downlink channel supported by the terminal, and the request includes: requesting downlink transmission that is corresponding to the repetition-related functionality of the downlink channel and that is transmitted to the terminal.

In this implementation, Msg1 can be used to indicate the payload size of the Msg3 PUSCH or whether the Msg3 PUSCH performs repetition, thereby making the indication or request. In particular, since the payload size of Msg3 PUSCH and whether Msg3 PUSCH performs repetition can be determined by the network during the Msg1 reception step, in this implementation, the common PDCCH/PDSCH can be the downlink channel before Msg3 transmission, such as Msg2/B PDCCH/PDSCH. For example, the network can determine the payload size of Msg3 PUSCH or whether Msg3 PUSCH performs repetition by detecting information such as the time-domain resource or frequency-domain resource of Msg1.

In the above implementation, the indication or request can be implemented without introducing additional messages, thereby saving transmission resources.

As an optional implementation, the target message is used to indicate at least one of the following:
a priority of the terminal, a type of the terminal, a frequency band in which the terminal operates, and a capability level of the terminal.

The priority of the terminal is used to indicate the repetition-related functionality of the downlink channel supported by the terminal, or to request downlink transmission that is corresponding to the repetition-related functionality of the downlink channel and that is transmitted to the terminal.

The type of the terminal is used to indicate the repetition-related functionality of the downlink channel supported by the terminal, or to request downlink transmission that is corresponding to the repetition-related functionality of the downlink channel and that is transmitted to the terminal.

The frequency band in which the terminal operates is used to indicate the repetition-related functionality of the downlink channel supported by the terminal, or to request downlink transmission that is corresponding to the repetition-related functionality of the downlink channel and that is transmitted to the terminal.

The capability level of the terminal is used to indicate the repetition-related functionality of the downlink channel supported by the terminal, or to request downlink transmission that is corresponding to the repetition-related functionality of the downlink channel and that is transmitted to the terminal.

In this implementation, the above target message may be any message that can explicitly or implicitly indicate the priority of the terminal, the type of the terminal, the frequency band in which the terminal operates, or the capability level of the terminal.

In this implementation, the above indication or request can be implemented based on at least one of the terminal's priority, type, frequency band, or capability level, without introducing additional messages, thereby saving transmission resources.

For example, a terminal with priority 1 supports Common PDCCH/PDSCH repetition. A terminal with priority 2 does not support Common PDCCH/PDSCH repetition.

For example, for customer premises equipment (CPE) terminals, downlink Common PDCCH/PDSCH repetition is supported, whereas for smart phones, downlink Common PDCCH/PDSCH repetition is not supported, as uplink coverage may be limited for smart phones.

For example, for frequency range (FR) 2, Common PDCCH/PDSCH repetition is supported, while for FR1, Common PDCCH/PDSCH repetition is not supported. This is because base stations in FR2 are typically smaller, with transmission power that is even comparable to that of a mobile phone.

For example, a terminal with capability level 1 can support common PDCCH/PDSCH repetition, while a terminal with capability level 2 does not support common PDCCH/PDSCH repetition.

For example, a terminal with capability level 1 can support dynamic and semi-static common PDCCH/PDSCH repetition, a terminal with capability level 2 can support semi-static common PDCCH/PDSCH repetition and does not support dynamic common PDCCH/PDSCH repetition, while a terminal with capability level 3 does not support common PDCCH/PDSCH repetition.

As an optional implementation, the repetition-related functionality of the downlink channel includes at least one of the following:
repetition of the downlink channel;
extension of a reception window of the downlink channel;
allowance for the repetition of the downlink channel exceeding the reception window corresponding to the downlink channel;
extension of a timer corresponding to the downlink channel; and
allowance for the repetition of the downlink channel exceeding duration of the timer corresponding to the downlink channel.

In some implementations, the reception window of the downlink channel includes at least one of the following: an RAR window and a MsgB response window.

In some implementations, the timer corresponding to the downlink channel includes a contention resolution timer.

The extension of the reception window of the downlink channel described above can involve expanding the reception window of the downlink channel, such as extending the duration of the reception window based on the existing reception window that does not support the corresponding downlink channel repetition, or redefining the reception window that supports the corresponding downlink channel repetition.

The extension of the timer corresponding to the downlink channel described above can involve expanding the timer corresponding to the downlink channel, such as extending the duration of the timer based on the existing timer that does not support the corresponding downlink channel repetition described above, or redefining the timer that supports the corresponding downlink channel repetition described above.

In this implementation, the terminal may support one or more of the above functionalities.

Additionally, the above functionalities can be related, for example, indicating that the terminal supports the extension of the reception window of the downlink channel also implies that the terminal supports downlink channel repetition, meaning the terminal has the capability to receive downlink channel repetitions. For another example, indicating that the terminal supports the allowance for the repetition of the downlink channel exceeding the reception window corresponding to the downlink channel also implies that the terminal supports downlink channel repetition, meaning the terminal has the capability to receive downlink channel repetitions. For another example, indicating the extension of the timer corresponding to the downlink channel also implies that the terminal supports downlink channel repetition, meaning the terminal has the capability to receive downlink channel repetitions. For another example, the allowance for the repetition of the downlink channel exceeding duration of the timer corresponding to the downlink channel also implies that the terminal supports downlink channel repetition, meaning the terminal has the capability to receive downlink channel repetitions.

Optionally, the repetition of the downlink channel includes at least one of the following:
repetition of the downlink channel of a single TRP;
repetition of the downlink channel between multiple TRPs;
repetitions of the downlink channel based on available slots;
repetition of the downlink channel based on physical slots;
repetition of the downlink channel supporting the extension of the reception window of the downlink channel;
repetition of the downlink channel not supporting the extension of the reception window of the downlink channel;
repetitions of the downlink channel supporting the allowance for the repetition of the downlink channel exceeding the reception window corresponding to the downlink channel;
repetition of the downlink channel not supporting the allowance for the repetition of the downlink channel exceeding the reception window corresponding to the downlink channel;
repetition of the downlink channel supporting the extension of the timer corresponding to the downlink channel;
repetition of the downlink channel not supporting the extension of the timer corresponding to the downlink channel;
repetition of the downlink channel supporting the allowance for the repetition of the downlink channel exceeding duration of the timer corresponding to the downlink channel;
repetition of the downlink channel not supporting the allowance for the repetition of the downlink channel exceeding duration of the timer corresponding to the downlink channel;
intra-slot repetitions of the downlink channel;
inter-slot repetitions of the downlink channel;
intra-control resource set repetitions of the downlink channel;
inter-control resource set repetitions of the downlink channel;
intra-CSS repetition of the downlink channel;
inter-CSS repetition of the downlink channel;
intra-monitoring occasion (MO) repetition of the downlink channel;
inter-MO repetition of the downlink channel;
time-domain repetition of the downlink channel;
frequency-domain repetition of the downlink channel;
dynamic repetition of the downlink channel;
semi-static repetition of the downlink channel;
repetition of the downlink channel before radio resource control (RRC) connection establishment; and
repetition of the downlink channel before receiving dedicated PDSCH configuration.

The repetition of the downlink channel of a single TRP described above may be a common PDCCH/PDSCH repetition targeted at a single TRP, or a common PDCCH/PDSCH repetition originating from a single TRP.

The repetition of the downlink channel between multiple TRPs described above may be a common PDCCH/PDSCH repetition targeted at multiple TRPs, or a common PDCCH/PDSCH repetition originating from multiple TRPs.

The above control resource set may be CORESET #0 or any other CORESET. The above CSS may be any one or more of the Type0/0A/1/2 CSS sets.

The above MO, which refers to the monitoring occasion for PDCCH, may belong to the same search space or to different search spaces.

The above time-domain repetition of the downlink channel may be referred to as time-domain downlink channel repetition, such as time-domain common PDCCH repetition. This time-domain repetition may be at least one of the following:
repetition on different PDCCH MOs within the same search space of the same CORESET;
repetition between different search spaces of the same or different CORESET; and
repetition within the same search space of different CORESETs.

The above frequency-domain repetition of the downlink channel may be referred to as frequency-domain downlink channel repetition, such as frequency-domain common PDCCH repetition. This frequency-domain repetition may be at least one of the following:
repetition on the same PDCCH MO within the same CORESET; and
repetition on the same PDCCH MO across different CORESETs.

The same PDCCH MO can be located within the same search space or across different search spaces. For example, different repetitions may involve multiple copies of the CORESET resources at the same time.

The above dynamic repetition of the downlink channel may refer to the repetition of the downlink channel determined dynamically.

The above semi-static repetition of the downlink channel may refer to the repetition of the downlink channel that is pre-configured or determined periodically.

The above repetition of the downlink channel before RRC connection establishment may refer to the repetition of all common PDCCH/PDSCH before RRC establishment. The repetition of the downlink channel before receiving the dedicated PDSCH configuration may refer to the repetition of all common PDCCH/PDSCH before the dedicated PDSCH configuration is received.

In the above implementations, various capabilities for downlink channel repetition are defined, allowing the terminal to flexibly indicate or request based on the needs, thereby enhancing the service performance of the terminal.

Optionally, in a case that the repetition of the downlink channel includes multiple types of repetitions, the multiple types of repetitions are independent terminal capabilities, or the multiple types of repetitions are combined terminal capabilities.

Alternatively, in a case that the repetition of the downlink channel includes multiple types of repetitions, the multiple types of repetitions are indicated by a same target message, or the multiple types of repetitions are indicated by at least two target messages.

The multiple types of repetitions described above may be all or part included in the repetition of the uplink channel.

The multiple types of repetitions are independent terminal capabilities described above, which may be that each can be understood as a separate capability. For example, dynamic downlink channel repetition and semi-static downlink channel repetition are independent capabilities. Alternatively, the multiple types of repetitions are combined terminal capabilities described above, which may be that the above multiple types of repetitions are considered as a whole. For example, dynamic downlink channel repetition and semi-static downlink channel repetition are considered as a single capability.

By using independent terminal capabilities, the flexibility of indications or requests can be increased, allowing each capability to be indicated or requested separately. When the above multiple types of repetitions are combined terminal capabilities, transmission overhead can be reduced.

The multiple types of repetitions are indicated by a same target message described above, allowing multiple types of capabilities to be indicated or requested with a single target message and saving transmission resources. The multiple types of repetitions are indicated by at least two target messages, which may be that each target message indicates or requests one or more capabilities, thereby achieving flexible indications or requests.

Optionally, the repetition of the downlink channel is defined at a granularity of the type of the terminal (i.e., defined for per user equipment (per UE) type), or the repetition of the downlink channel is defined at a granularity of the priority of the terminal (i.e., defined for the priority of per UE).

The type of the terminal described above may be a low-capability terminal (RedCap UE) or a non-RedCap UE, or a terrestrial network (TN) terminal or a non-terrestrial network (NTN) terminal.

In this implementation, the repetition of the downlink channel can be defined at the granularity of the type of the terminal or at the granularity of the priority of the terminal, allowing for a more refined definition of downlink channel repetition to better meet a wider range of scenarios or business requirements.

Optionally, a capability of the repetition of the downlink channel matches a target downlink channel repetition capability, and the target downlink channel repetition capability is a downlink channel repetition capability of the terminal after entering the connected state.

The capability of the repetition of the downlink channel matches the target downlink channel repetition capability described above, which may be that the repetition of the uplink channel is consistent with a PDCCH/PDSCH repetition capability when the terminal enters the connected state.

For example, the above capability may be the existing PDSCH multi-slot repetition (pdsch-RepetitionMultiSlots) capability, that is, as long as the terminal has the pdsch-RepetitionMultiSlots capability, the network can consider the terminal to also have the common PDSCH repetition capability.

For another example, the above capability may be a multi-TRP PDCCH repetition (mTRP-PDCCH-Repetition) capability, that is, as long as the UE has the mTRP-PDCCH-Repetition-r17 capability, the network can consider the terminal to also have the common PDCCH repetition capability.

In this implementation, since the capability of the repetition of the downlink channel matches the target downlink channel repetition capability, this can reduce the need for capability reporting and save transmission overhead.

Optionally, in a case that the terminal supports the repetition of the downlink channel, the terminal supports the extension of the reception window of the downlink channel.

Alternatively, in a case that the terminal supports the repetition of the downlink channel, the terminal supports the allowance for the repetition of the downlink channel exceeding the reception window corresponding to the downlink channel.

Alternatively, in a case that the terminal supports the repetition of the downlink channel, the terminal supports the extension of the timer corresponding to the downlink channel.

Alternatively, in a case that the terminal supports the repetition of the downlink channel, the terminal supports the allowance for the repetition of the downlink channel exceeding duration of the timer corresponding to the downlink channel.

In this implementation, it can be implemented that when the terminal supports the repetition of the downlink channel, it is determined that the terminal supports at least one of the following:
extension of a reception window of the downlink channel;
allowance for the repetition of the downlink channel exceeding the reception window corresponding to the downlink channel;
extension of a timer corresponding to the downlink channel; and
allowance for the repetition of the downlink channel exceeding duration of the timer corresponding to the downlink channel.

In this way, the overhead of the target message can be reduced.

Optionally, in a case that the repetition-related functionality of the downlink channel includes multiple types of functions, the multiple types of functions are indicated by the same target message, or the multiple types of functions are indicated by at least two target messages.

The above multiple types of functions refer to multiple types of the following:
repetition of the downlink channel;
extension of a reception window of the downlink channel;
allowance for the repetition of the downlink channel exceeding the reception window corresponding to the downlink channel;
extension of a timer corresponding to the downlink channel; or
allowance for the repetition of the downlink channel exceeding duration of the timer corresponding to the downlink channel.

The above multiple types of functions are indicated by the same target message, so that transmission resources can be saved. The above multiple types of functions are indicated by at least two target messages, which may be that the same target message indicates or requests one or more of the above items, enabling more flexible indications or requests.

As an optional implementation, the transmitting, by a terminal, a target message includes:
transmitting, by the terminal, the target message under target conditions, the target conditions including at least one of the following:
a reference signal received power (RSRP) of a downlink signal is greater than or equal to a first threshold;
a reference signal received quality (RSRQ) of the downlink signal is greater than or equal to a second threshold;
an uplink channel corresponding to the downlink channel performs repetition, or the uplink channel corresponding to the downlink channel does not perform repetition;
a same repetition request condition is used for all or part of the channels of the downlink channel;
a RSRQ threshold for all or part of the channels of the downlink channel is the same, or the RSRP threshold for all or part of the channels of the downlink channel is different; and
a RSRQ threshold for all or part of the channels of the downlink channel is the same, or the RSRQ threshold for all or part of the channels of the downlink channel is different.

The above downlink signal can be a downlink reference signal, for example, a reference signal used for estimating path loss (pathloss).

The above uplink channel corresponding to the downlink channel performs repetition, which may be that Msg1, MsgA, Msg3, or the hybrid automatic repeat request acknowledgement (HARQ-ACK) for Msg4 has performed repetition.

The above uplink channel corresponding to the downlink channel does not perform repetition, which may be that Msg1, MsgA, Msg3, or the hybrid automatic repeat request acknowledgement (HARQ-ACK) for Msg4 has not performed repetition.

In particular, the above target conditions can be defined by protocol specifications, configured by the network side, or determined by the terminal.

In this implementation, the above target message can be transmitted only under the above target conditions, thereby saving transmission overhead.

As an optional implementation, the method further includes:
in a case that the terminal has not transmitted the target message, receiving, by the terminal, configuration information, the configuration information being used to configure repetition resources of the downlink channel.

In a case that the terminal supports the repetition-related functionality of the downlink channel, the terminal performs blind detection on the repetition resources and non-repetition resources of the downlink channel, or, in a case that the terminal does not support the repetition-related functionality of the downlink channel, the terminal performs blind detection on the non-repetition resources of the downlink channel.

The above configuration information can be configured through system information, for example, configured through a master information block (MIB).

In a case that the terminal has not transmitted the target message, the receiving, by the terminal, configuration information can mean that the terminal receives the above configuration information before transmitting the above target message.

Additionally, the terminal performs blind detection on the repetition resources and non-repetition resources of the downlink channel, which may be that the terminal performs blind detection on the repetition resources and non-repetition resources of the downlink channel either before transmitting the above target message or after transmitting the target message.

In this implementation, it can be implemented that in a case that the target message has not been transmitted, if the terminal supports the repetition-related functionality of the downlink channel, the terminal can perform blind detection on the repetition resources and non-repetition resources of the downlink channel, thereby enhancing the terminal's downlink channel reception performance.

In the embodiments of the present application, the terminal transmits a target message, the target message being used for at least one of the following: indicating repetition-related functionality of a downlink channel supported by the terminal; and requesting downlink transmission that is corresponding to the repetition-related functionality of the downlink channel and that is transmitted to the terminal, where the downlink channel includes at least one of the following: a common PDCCH and a common PDSCH. This supports repetition for at least one of the common PDCCH or common PDSCH, thereby enhancing a success rate of the terminal receiving the downlink channel and enhancing the service performance of the terminal.

For example, in some scenarios, such as NTN scenarios, when a satellite needs to support multiple beams, the downlink transmit power for each beam may be reduced. In this case, the Common PDCCH, such as the PDCCH scheduling Msg2/MsgB/Msg4, or the common PDSCH, such as the PDSCH carrying Msg2, MsgB, or Msg4, may experience degraded reception performance due to the lack of repetition support. This results in the failure to complete random access, which in turn prevents all service (such as voice over new radio (VoNR), low-speed data transmission) channels from proceeding further. In this case, the embodiments of the present application support the reporting of the Common PDCCH and common PDSCH repetition functionality, or the terminal's request for common PDCCH/PDSCH repetition (for example, the terminal requests network scheduling for common PDCCH/PDSCH repetition only under certain conditions). Additionally, to ensure that the terminal can receive the relevant downlink PDSCH channels while supporting downlink repetition functionality within a specified time, the embodiments of the present application support the extension of the RAR window or the extension of the contention resolution timer time length. It also allows the terminal to indicate these capabilities to the network, and the network side can determine whether to configure the terminal to perform these functionalities.

For another example, to allow the network to be aware of the terminal's capability or request for retransmitting the common PDCCH/PDSCH, the embodiments of the present application can combine some functionalities into a single common terminal capability, thereby reducing the complexity of terminal capability reporting or repetition requests.

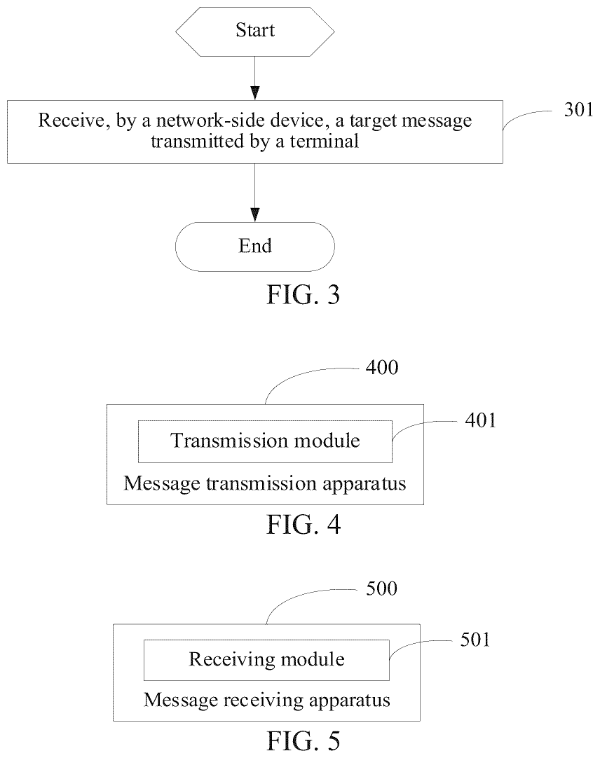

Referring to FIG. 3, FIG. 3 is a flowchart of a message receiving method according to an embodiment of the present application. As shown in FIG. 3, the method includes the following steps:
Step 301: A network-side device receives a target message transmitted by a terminal, the target message being used for at least one of the following:
indicating repetition-related functionality of a downlink channel supported by the terminal; and
requesting downlink transmission that is corresponding to the repetition-related functionality of the downlink channel and that is transmitted to the terminal.

The downlink channel includes at least one of the following:
a common physical downlink control channel PDCCH and a common physical downlink shared channel PDSCH.

Optionally, the common PDCCH includes at least one of the following:
a PDCCH to be transmitted to the terminal before entering a connected state; and
a PDCCH transmitted on common PDCCH resources.

Alternatively,
the common PDSCH includes:
a PDSCH to be transmitted to the terminal before entering the connected state.

Optionally, the target message includes at least one of the following:
a physical random access channel PRACH, Msg1, Msg3 PUSCH, MsgA, MsgA PUSCH, and a message transmitted by the terminal in the connected state.

Optionally, the PRACH is used for the indication/request through at least one of the following:
a time-domain resource of the PRACH, a frequency-domain resource of the PRACH, a configuration index of the PRACH, a sequence of the PRACH, a scrambling sequence of a sequence of the PRACH, a format of the PRACH, and whether the PRACH performs repetition.

Alternatively,
the MsgA PUSCH is used for the indication/request through at least one of the following:
information carried by the MsgA PUSCH, a time-domain resource of the MsgA PUSCH, a frequency-domain resource of the MsgA PUSCH, a demodulation reference signal DMRS resource of the MsgA PUSCH, a group in which the MsgA PUSCH is located, and whether the MsgA PUSCH performs repetition.

Alternatively,
the MsgA is used for the indication/request through at least one of the following:
a time-domain resource of the MsgA, a frequency-domain resource of the MsgA, and a DMRS resource of the MsgA.

Alternatively,
the Msg3 PUSCH is used for the indication/request through at least one of the following:
information carried by the Msg3 PUSCH, a time-domain resource of the Msg3 PUSCH, a frequency-domain resource of the Msg3 PUSCH, a DMRS resource of the Msg3 PUSCH, a payload size of the Msg3 PUSCH, and whether the Msg3 PUSCH performs repetition.

Alternatively,
the Msg1 is used to indicate the payload size of the Msg3 PUSCH or whether the Msg3 PUSCH performs repetition, where the payload size of the Msg3 PUSCH or whether the Msg3 PUSCH performs repetition is used for indication or request.

The indication includes: indicating the repetition-related functionality of the downlink channel supported by the terminal, and the request includes: requesting downlink transmission that is corresponding to the repetition-related functionality of the downlink channel and that is transmitted to the terminal.

Optionally, the target message is used to indicate at least one of the following:
a priority of the terminal, a type of the terminal, a frequency band in which the terminal operates, and a capability level of the terminal.

The priority of the terminal is used to indicate the repetition-related functionality of the downlink channel supported by the terminal, or to request downlink transmission that is corresponding to the repetition-related functionality of the downlink channel and that is transmitted to the terminal.

The type of the terminal is used to indicate the repetition-related functionality of the downlink channel supported by the terminal, or to request downlink transmission that is corresponding to the repetition-related functionality of the downlink channel and that is transmitted to the terminal.

The frequency band in which the terminal operates is used to indicate the repetition-related functionality of the downlink channel supported by the terminal, or to request downlink transmission that is corresponding to the repetition-related functionality of the downlink channel and that is transmitted to the terminal.

The capability level of the terminal is used to indicate the repetition-related functionality of the downlink channel supported by the terminal, or to request downlink transmission that is corresponding to the repetition-related functionality of the downlink channel and that is transmitted to the terminal.

Optionally, the repetition-related functionality of the downlink channel includes at least one of the following:
repetition of the downlink channel;
extension of a reception window of the downlink channel;
allowance for the repetition of the downlink channel exceeding the reception window corresponding to the downlink channel;
extension of a timer corresponding to the downlink channel; and
allowance for the repetition of the downlink channel exceeding duration of the timer corresponding to the downlink channel.

Optionally, the reception window of the downlink channel includes at least one of the following: an RAR window and a MsgB response window.

Alternatively, the timer corresponding to the downlink channel includes a contention resolution timer.

Optionally, the repetition of the downlink channel includes at least one of the following:
repetition of the downlink channel of a single TRP;
repetition of the downlink channel between multiple TRPs;
repetitions of the downlink channel based on available slots;
repetition of the downlink channel based on physical slots;
repetition of the downlink channel supporting the extension of the reception window of the downlink channel;
repetition of the downlink channel not supporting the extension of the reception window of the downlink channel;
repetitions of the downlink channel supporting the allowance for the repetition of the downlink channel exceeding the reception window corresponding to the downlink channel;
repetition of the downlink channel not supporting the allowance for the repetition of the downlink channel exceeding the reception window corresponding to the downlink channel;
repetition of the downlink channel supporting the extension of the timer corresponding to the downlink channel;
repetition of the downlink channel not supporting the extension of the timer corresponding to the downlink channel;
repetition of the downlink channel supporting the allowance for the repetition of the downlink channel exceeding duration of the timer corresponding to the downlink channel;
repetition of the downlink channel not supporting the allowance for the repetition of the downlink channel exceeding duration of the timer corresponding to the downlink channel;
intra-slot repetitions of the downlink channel;
inter-slot repetitions of the downlink channel;
intra-control resource set repetitions of the downlink channel;
inter-control resource set repetitions of the downlink channel;
intra-common search space CSS repetitions of the downlink channel;
inter-CSS repetition of the downlink channel;
intra-monitoring occasion repetition of the downlink channel;
inter-monitoring occasion repetitions of the downlink channel;
time-domain repetition of the downlink channel;
frequency-domain repetition of the downlink channel;
dynamic repetition of the downlink channel;
semi-static repetition of the downlink channel;
repetition of the downlink channel before radio resource control RRC connection establishment; and
repetition of the downlink channel before receiving dedicated PDSCH configuration.

Optionally, in a case that the repetition of the downlink channel includes multiple types of repetitions, the multiple types of repetitions are independent terminal capabilities, or the multiple types of repetitions are combined terminal capabilities.

Alternatively, in a case that the repetition of the downlink channel includes multiple types of repetitions, the multiple types of repetitions are indicated by a same target message, or the multiple types of repetitions are indicated by at least two target messages.

Optionally, the repetition of the downlink channel is defined at a granularity of the type of the terminal, or the repetition of the downlink channel is defined at a granularity of the priority of the terminal.

Optionally, a capability of the repetition of the downlink channel matches a target downlink channel repetition capability, and the target downlink channel repetition capability is a downlink channel repetition capability of the terminal after entering the connected state.

Optionally, in a case that the terminal supports the repetition of the downlink channel, it is determined that the terminal supports the extension of the reception window of the downlink channel.

Alternatively, in a case that the terminal supports the repetition of the downlink channel, it is determined that the terminal supports the allowance for the repetition of the downlink channel exceeding the reception window corresponding to the downlink channel.

Alternatively, in a case that the terminal supports the repetition of the downlink channel, it is determined that the terminal supports the extension of the timer corresponding to the downlink channel.

Alternatively, in a case that the terminal supports the repetition of the downlink channel, it is determined that the terminal supports the allowance for the repetition of the downlink channel exceeding duration of the timer corresponding to the downlink channel.

Optionally, in a case that the repetition-related functionality of the downlink channel includes multiple types of functions, the multiple types of functions are indicated by the same target message, or the multiple types of functions are indicated by at least two target messages.

Optionally, the common PDSCH includes at least one of the following:
Msg2 PDSCH, MsgB PDSCH, and Msg4 PDSCH.

Alternatively, the common PDCCH includes at least one of the following:
SIB1 PDCCH, OSI PDCCH, Msg2 PDCCH, Msg4 PDCCH, MsgB PDCCH, Paging PDCCH, and PDCCH scheduling Msg3 retransmission.

Optionally, the method further includes:
in a case that the target message transmitted by the terminal has not been received, transmitting, by the network-side device, configuration information to the terminal, the configuration information being used to configure repetition resources of the downlink channel.

It is to be noted that this embodiment, as an implementation of the network-side device corresponding to the embodiment shown in FIG. 2, can refer to the relevant description of the embodiment shown in FIG. 2 for specific implementation details. To avoid repetition, this embodiment may not be elaborated further.

The following multiple embodiments illustrate the methods according to the embodiments of the present application:

### Embodiment 1

This embodiment mainly describes the indication of Common PDCCH/PDSCH repetition capability or the indication of repetition request, as detailed below.

In some embodiments, the indication of Common PDCCH/PDSCH repetition reception capability or repetition request is at least provided through PRACH resources or information indications. The PRACH resources or information herein may include one or more of the following:
a time-domain resource of the PRACH, a frequency-domain resource of the PRACH, a configuration index of the PRACH, a sequence of the PRACH, a scrambling sequence of a sequence of the PRACH, a format of the PRACH, and whether the PRACH performs repetition.

For example, a set of preamble sequence indexes (or other factors described above) may be predefined, where the PRACH corresponding to a specific preamble sequence index implicitly indicates that one or more of the subsequent common PDCCH/PDSCH transmissions may be retransmitted.

For example, as long as the terminal supports PRACH repetition, the terminal may support receiving one or more subsequent common PDCCH/PDSCH repetitions.

The above PRACH may be the Msg1 PRACH or the MsgA PRACH.

In some embodiments, the common PDCCH/PDSCH repetition capability or repetition request is at least indicated through MsgA PUSCH, including one or more of the following methods:
explicit indication through information carried in MsgA PUSCH, such as by reusing existing fields, introducing new fields, or using the logical channel identifier (logical channel ID) for indication; or
implicit indication through MsgA PUSCH, including one or more of the following aspects:
a time-domain resource of the MsgA PUSCH, a frequency-domain resource of the MsgA PUSCH, a DMRS resource of the MsgA PUSCH, a group in which the MsgA PUSCH is located, or whether the MsgA PUSCH performs repetition.

For example, multiple sets of MsgA PUSCH resources can be independently configured for terminals that support common PDCCH/PDSCH repetition and for terminals that do not support common PDCCH/PDSCH repetition. The network determines whether a terminal supports common PDCCH/PDSCH repetition functionality according to the MsgA PUSCH resources used by the detected terminal.

For another example, in the MsgA configuration of the 2-step RACH, two sets of PUSCH transmission occasions are configured: PO group A and PO group B. PO group A is used by terminals that support common PDCCH/PDSCH repetition, while PO group B is used by terminals that do not support common PDCCH/PDSCH repetition. The network determines whether a terminal supports receiving or requesting PDCCH/PDSCH repetition by detecting the PUSCH on the two PO groups.

The 2-step RACH does not involve the transmission of Msg4. However, when the 2-step RACH falls back or switches to the 4-step RACH, the corresponding MsgA PUSCH transmission is still performed. In this case, the MsgA PUSCH may be used to indicate the repetition capability of the corresponding Msg4 PDCCH/PDSCH.

In some embodiments, the common PDCCH/PDSCH repetition capability or repetition request is at least implicitly and indirectly indicated by MsgA, including one or more of the following methods:
a time-domain resource of the MsgA, a frequency-domain resource of the MsgA, and a DMRS resource of the MsgA.

For example, two sets of MsgA resources can be independently configured, with one set allocated to terminals supporting common PDCCH/PDSCH repetition and the other set to terminals that do not support common PDCCH/PDSCH repetition. The network determines the terminal's common PDCCH/PDSCH repetition capability according to the MsgA resources used by the detected terminal.

In some embodiments, the common PDCCH/PDSCH repetition capability or repetition request is at least determined by Msg3 PUSCH-related parameters/attributes, including one or more of the following methods:
explicit indication through information carried in Msg3 PUSCH, such as by reusing existing fields, introducing new fields, or using the logical channel ID for indication, for example, using the spare bits in Msg3; or
implicit indication through Msg3 PUSCH, including one or more of the following aspects:
a time-domain resource of the Msg3 PUSCH, a frequency-domain resource of the Msg3 PUSCH, a DMRS resource of the Msg3 PUSCH, payload size (Preamble group A, Preamble group B) of the Msg3 PUSCH, and whether the Msg3 PUSCH performs repetition (i.e., whether it selects PRACH resources that support msg3 repetition).

The above common PDCCH/PDSCH may be a Msg4 PDCCH/PDSCH after Msg3 transmission.

Additionally, since the payload size of Msg3 and whether Msg3 performs repetition can be determined by the network during the Msg1 reception step, the common PDCCH/PDSCH can also be the downlink channel before Msg3 transmission, such as Msg2/B PDCCH/PDSCH.

In some embodiments, the reporting of terminal capability for Common PDCCH/PDSCH repetition or the request for Common PDCCH/PDSCH repetition is determined using one or more of the following methods:

It is determined based on the priority of the terminal, such as the priority of the terminal indicated by Msg3. For example, a terminal with priority 1 supports Common PDCCH/PDSCH repetition, while a terminal with priority 2 does not support Common PDCCH/PDSCH repetition.

It is determined based on the type of the terminal. For example, for CPE terminals, downlink Common PDCCH/PDSCH repetition is supported, whereas for smart phones, downlink Common PDCCH/PDSCH repetition is not supported. This is because uplink coverage may be limited for smart phones.

It is determined based on the frequency band. For example, FR2 supports Common PDCCH/PDSCH repetition, while FR1 does not support Common PDCCH/PDSCH repetition. This is because FR2 base stations are typically smaller, with transmission power that is even closer to that of a mobile phone.

It is determined based on the capability level of the terminal. For example, a terminal with capability level 1 can support common PDCCH/PDSCH repetition, while a terminal with capability level 2 does not support common PDCCH/PDSCH repetition. For another example, a terminal with capability level 1 can support dynamic and semi-static common PDCCH/PDSCH repetition, a terminal with capability level 2 can support semi-static common PDCCH/PDSCH repetition and does not support dynamic common PDCCH/PDSCH repetition, while a terminal with capability level 3 does not support common PDCCH/PDSCH repetition.

In some embodiments, dynamic common PDCCH/PDSCH repetition and semi-static common PDCCH/PDSCH repetition are separate UE capabilities.

For example, when the network configures a repetition factor in SIB1, such a common PDCCH/PDSCH repetition can correspond to semi-static repetition capability. When the network configures multiple repetition factors in SIB1, the network can dynamically configure the terminal to use one of these repetition factors for each common PDCCH/PDSCH transmission. Such a common PDCCH/PDSCH repetition can correspond to dynamic repetition capability.

In some embodiments, dynamic common PDCCH/PDSCH repetition and semi-static common PDCCH/PDSCH repetition are considered a single terminal capability.

In some embodiments, the common PDCCH/PDSCH repetition capability includes one or more of the following combinations:
common PDCCH/PDSCH repetition for a single TRP;
common PDCCH/PDSCH repetition for multiple TRPs;
common PDCCH/PDSCH repetition based on available slots;
common PDCCH/PDSCH repetition based on physical slots;
whether RAR window extension is supported;
whether Msg2 PDCCH/PDSCH repetition beyond the RAR window is supported;
whether contention resolution timer duration extension is supported;
whether Msg4 PDCCH/PDSCH repetition beyond the contention resolution timer duration is supported;
intra-slot common PDCCH/PDSCH repetition;
inter-slot common PDCCH/PDSCH repetition;
intra-control resource set (Intra-coreset) common PDCCH repetition;
inter-control resource set (Inter-coreset) common PDCCH repetition, where CORESET may be CORESET #0 or any other CORESET;
intra-CSS (Intra-CSS) common PDCCH repetition;
inter-CSS (Inter-CSS) common PDCCH repetition, where CSS can be any one or more of Type0/0A/1/2 CSS sets;
intra-MO (Intra-MO) common PDCCH repetition;
inter-MO (Inter-MO) common PDCCH repetition, where the above MO, which refers to the monitoring occasion for PDCCH, may belong to the same search space or to different search spaces;
time-domain common PDCCH repetition, which may be at least one of the following: repetition on different PDCCH MOs within the same search space of the same CORESET; repetition between different search spaces of the same or different CORESET; and repetition within the same search space of different CORESETS; or
frequency-domain common PDCCH repetition, which may be at least one of the following: repetition on the same PDCCH MO within the same CORESET; and repetition on the same PDCCH MO across different CORESETS. The same PDCCH MO can be located within the same search space or across different search spaces. For example, different repetitions may involve multiple copies of the CORESET resources at the same time.

Common PDCCH/PDSCH repetition originates from a single TRP.

Common PDCCH/PDSCH repetition originates from multiple TRPs.

In some embodiments, the above two or more capabilities are either separate UE capabilities or combined terminal capabilities.

In some embodiments, the definition of the Common PDCCH/PDSCH repetition capability or the Common PDCCH/PDSCH repetition request is defined per type of the terminal or per priority of the terminal. Different types of terminals, for example, can be RedCap terminals or non-RedCap terminals, or TN terminals or NTN terminals.

In some embodiments, when there are multiple types of repetition capabilities for common PDCCH/PDSCH, the combinations of these capabilities can be reported through different PRACH/MsgA/MsgA-PUSCH/Msg3-related parameters/attributes or through explicit information.

For example, various Msg2/MsgB/Msg4 PDCCH/PDSCH repetition capabilities are distinguished using different PRACH preamble groups. Assuming that the terminal needs to report whether it supports Msg2/MsgB/Msg4 PDCCH/PDSCH repetition based on available slots or supports RAR window extension, four preamble groups are defined for each PRACH occasion. Group A indicates support for repetition based on available slots, group B indicates support for repetition with RAR window extension, group C indicates support for both repetition based on available slots and repetition with RAR window extension, and group D indicates that neither type of repetition is supported. For example, Table 1 shows:

TABLE 1

| | | Msg2/MsgB/Msg4 |
|---|---|---|
| | Msg2/MsgB/Msg4 | PDCCH/PDSCH repetition |
| Preamble | PDCCH/PDSCH repetition | supporting RAR window |
| group | based on available slots | extension |
| A | Yes | No |
| B | No | Yes |
| C | Yes | Yes |
| D | No | No |

In some embodiments, after the terminal enters the RRC connected state, it reports the capability for common PDCCH/PDSCH repetition. The capability reporting can be done in one or more of the following ways:

The common PDCCH/PDSCH repetition capabilities for different types (e.g., Msg2/MsgB/Msg4 PDCCH/PDSCH channels) are reported independently. For example, for Common PDCCH repetition, there can be terminal capabilities or requests for SIB1 PDCCH repetition, OSI PDCCH repetition, Msg2/4/B PDCCH repetition, Paging PDCCH repetition, and PDCCH repetition for scheduling Msg3 retransmissions.

The common PDCCH/PDSCH repetition capabilities for different types (e.g., Msg2/MsgB/Msg4 PDCCH/PDSCH channels) are combined into a single capability. For example, the terminal only needs to report a single terminal capability for receiving common PDCCH repetition, indicating that the terminal can support repetitions for all Common PDCCH channels (SIB1 PDCCH, OSI PDCCH, Msg2/4/B PDCCH, Paging PDCCH, and PDCCH for scheduling Msg3 retransmissions).

Additionally, in some embodiments, one or more of the following downlink common PDCCH/PDSCH repetition capabilities of different types are defined:
all common PDCCH/PDSCH repetitions before RRC establishment;
all common PDCCH/PDSCH repetitions before the dedicated PDSCH configuration is received; or
common PDCCH/PDSCH repetitions consistent with a PDCCH/PDSCH repetition capability when the terminal enters the connected state, where for example, the above capability may be the existing PDSCH multi-slot repetition (pdsch-RepetitionMultiSlots) capability, that is, as long as the terminal has the pdsch-RepetitionMultiSlots capability, the network can consider the terminal to also have the common PDSCH repetition capability; for another example, the above capability may be a multi-TRP PDCCH repetition (mTRP-PDCCH-Repetition) capability, that is, as long as the terminal has the mTRP-PDCCH-Repetition-r17 capability, the network can consider the terminal to also have the common PDCCH repetition capability.

In some embodiments, if there is no reporting or request from the terminal for common PDCCH repetition capability, the network configures the PDCCH repetition resources through the MIB, and the terminal receives the repetitions based on its own capabilities.

For example, a terminal without PDCCH repetition capability may only perform blind detection at the legacy PDCCH transmission position.

A terminal with PDCCH repetition capability may perform blind detection at both the legacy PDCCH and repetition PDCCH transmission positions.

In some embodiments, the Common PDCCH/PDSCH repetition request needs to meet one or more of the following conditions:

The RSRP/RSRQ for downlink signal measurement exceeds or is greater than a threshold, where the downlink signal, such as a reference signal used for estimating path loss (pathloss), is considered.

Whether the corresponding Msg1, MsgA, Msg3, or the PUCCH for Msg4 HARQ-ACK feedback has performed repetition.

One or more different Common PDCCH/PDSCHs, such as Msg2/MsgB/Msg4/Paging PDCCH/PDSCH, use at least one common repetition request condition.

The RSRP/RSRQ threshold for downlink signal measurement may be the same or different for Common PDCCH/PDSCH. For example, the RSRP threshold corresponding to the Msg2/MsgB/Msg4 PDCCH/PDSCH repetition request can be determined by adding a different RSRP offset relative to a reference RSRP.

### Embodiment 2

This embodiment mainly describes the determination of the RAR (Msg2 or MsgB) window extension (i.e., the reception window extension mentioned in the above embodiments) or the ability for Msg2/MsgB repetition beyond the RAR window, as detailed below:

In some embodiments, the reception of Msg2/MsgB PDCCH needs to be completed within the RAR window or the MsgB response window. When Msg2/MsgB PDCCH is retransmitted, to support a sufficient number of repetitions, the length of the RAR window is extended in this embodiment, and the terminal is required to have the corresponding capability.

In some embodiments, to allow the network to transmit multiple RARs within the RAR window (similar to multiple RAR transmissions within the RAR window), the transmission time of the RAR PDSCH may need to be completed within the RAR window. When RAR PDSCH supports repetition, the length of the RAR window is extended in this embodiment. Moreover, it is also necessary to consider whether RAR repetition is allowed to extend beyond the RAR window.

In some embodiments, the ability for RAR window extension or Msg2/MsgB PDCCH/PDSCH repetition beyond the RAR window can also be indicated by one or more of the methods previously used to indicate the common PDCCH/PDSCH repetition capability in Embodiment 1.

In some embodiments, the ability for RAR window extension or Msg2/MsgB PDCCH/PDSCH repetition beyond the RAR window is determined by the Msg2/MsgB PDCCH/PDSCH repetition capability. For example, as long as the terminal supports Msg2/MsgB PDCCH/PDSCH repetition, it also supports RAR window extension or Msg2/MsgB PDCCH/PDSCH repetition beyond the RAR window.

In some embodiments, the ability for RAR window extension or Msg2/MsgB PDCCH/PDSCH repetition beyond the RAR window is mandatory.

In some embodiments, the ability for RAR window extension or Msg2/MsgB PDCCH/PDSCH repetition beyond the RAR window, or the Common PDCCH/PDSCH repetition capability, can be reported independently for different types of terminals. Different types of terminals, for example, can be RedCap terminals or non-RedCap terminals.

### Embodiment 3

This embodiment mainly describes the determination of the ability for Contention resolution timer or Msg4 PDCCH/PDSCH repetition beyond the Contention resolution timer duration, as detailed below:

In some embodiments, the reception of Msg4 PDCCH needs to be completed before the contention resolution timer expires. When Msg4 PDCCH is retransmitted, to support a sufficient number of repetitions, the length of the contention resolution timer is extended in this embodiment, and the terminal is required to have the corresponding capability.

In some embodiments, to allow the network to schedule multiple Msg4 transmissions within the Contention resolution timer duration (similar to multiple Msg4 transmissions within the Contention resolution timer duration), the transmission time of Msg4 may need to be completed within the Contention resolution timer duration. When Msg4 supports repetition, the length of the Contention resolution timer duration is extended in this embodiment. Moreover, it is also necessary to consider whether Msg4 repetition is allowed to extend beyond the Contention resolution timer duration.

In some embodiments, the ability for Contention resolution timer duration extension or Msg4 PDCCH/PDSCH repetition beyond the Contention resolution timer duration can also be indicated by one or more of the methods previously used to indicate the common PDCCH/PDSCH repetition capability in Embodiment 1.

In some embodiments, the ability for Contention resolution timer duration extension or Msg4 PDCCH/PDSCH repetition beyond the Contention resolution timer duration is determined by the Msg4 PDCCH/PDSCH repetition capability. For example, as long as the terminal supports Msg4 PDCCH/PDSCH repetition, it also supports the ability for Contention resolution timer duration extension or Msg4 PDCCH/PDSCH repetition beyond the Contention resolution timer duration.

In some embodiments, the ability for Contention resolution timer duration extension or Msg4 PDCCH/PDSCH repetition beyond the Contention resolution timer duration is mandatory.

In some embodiments, the ability for Contention resolution timer duration extension or Msg4 PDCCH/PDSCH repetition beyond the Contention resolution timer duration, or the Common PDCCH/PDSCH repetition capability, can be reported independently for different types of terminals. Different types of terminals, for example, can be RedCap terminals or non-RedCap terminals.

The embodiments of the present application introduce the indication or transmission request for Common PDCCH/PDSCH repetition reception functions, enabling the network to activate these enhanced technologies, thereby enhancing the transmission reliability of common PDCCH/PDSCH, ensuring a high success rate for random access, and reducing the random access delay. Additionally, the embodiments of the present application can also combine some terminal functionalities that can be combined, thereby reducing the complexity of terminal capability reporting or repetition requests and enhancing resource utilization. Conditional capability reporting, i.e., repetition requests, is introduced to avoid using common PDCCH/PDSCH repetition for terminals that do not have coverage problems, thereby enhancing the service performance of these terminals.

The message transmission method according to the embodiments of the present application may be executed by a message transmission apparatus. In the embodiments of the present application, a notification apparatus is used as an example to perform the message transmission method, illustrating the message transmission apparatus according to the embodiments of the present application.

The message receiving method according to the embodiments of the present application may be executed by a message receiving apparatus. In the embodiments of the present application, a notification apparatus is used as an example to perform the message receiving method, illustrating the message receiving apparatus according to the embodiments of the present application.

Referring to FIG. 4, FIG. 4 is a structural diagram of a message transmission apparatus according to an embodiment of the present application. As shown in FIG. 4, the message transmission apparatus 400 includes:
a transmission module 401, configured to transmit a target message, the target message being used for at least one of the following:
indicating repetition-related functionality of a downlink channel supported by the terminal; and
requesting downlink transmission that is corresponding to the repetition-related functionality of the downlink channel and that is transmitted to the terminal.

The downlink channel includes at least one of the following:
a common PDCCH and a common PDSCH.

Optionally, the common PDCCH includes at least one of the following:
a PDCCH to be received by the terminal before entering a connected state; and
a PDCCH transmitted on common PDCCH resources.

Alternatively,
the common PDSCH includes:
a PDSCH to be received by the terminal before entering the connected state.

Optionally, the target message includes at least one of the following:
PRACH, Msg1, Msg3 PUSCH, MsgA, MsgA PUSCH, and a message transmitted by the terminal in the connected state.

Optionally, the PRACH is used for the indication/request through at least one of the following:
a time-domain resource of the PRACH, a frequency-domain resource of the PRACH, a configuration index of the PRACH, a sequence of the PRACH, a scrambling sequence of a sequence of the PRACH, a format of the PRACH, and whether the PRACH performs repetition.

Alternatively,
the MsgA PUSCH is used for the indication/request through at least one of the following:
information carried by the MsgA PUSCH, a time-domain resource of the MsgA PUSCH, a frequency-domain resource of the MsgA PUSCH, a demodulation reference signal DMRS resource of the MsgA PUSCH, a group in which the MsgA PUSCH is located, and whether the MsgA PUSCH performs repetition.

Alternatively,
the MsgA is used for the indication/request through at least one of the following:
a time-domain resource of the MsgA, a frequency-domain resource of the MsgA, and a DMRS resource of the MsgA.

Alternatively,
the Msg3 PUSCH is used for the indication/request through at least one of the following:
information carried by the Msg3 PUSCH, a time-domain resource of the Msg3 PUSCH, a frequency-domain resource of the Msg3 PUSCH, a DMRS resource of the Msg3 PUSCH, a payload size of the Msg3 PUSCH, and whether the Msg3 PUSCH performs repetition.

Alternatively,
the Msg1 is used to indicate the payload size of the Msg3 PUSCH or whether the Msg3 PUSCH performs repetition, where the payload size of the Msg3 PUSCH or whether the Msg3 PUSCH performs repetition is used for indication or request.

The indication includes: indicating the repetition-related functionality of the downlink channel supported by the terminal, and the request includes: requesting downlink transmission that is corresponding to the repetition-related functionality of the downlink channel and that is transmitted to the terminal.

Optionally, the target message is used to indicate at least one of the following:
a priority of the terminal, a type of the terminal, a frequency band in which the terminal operates, and a capability level of the terminal.

The priority of the terminal is used to indicate the repetition-related functionality of the downlink channel supported by the terminal, or to request downlink transmission that is corresponding to the repetition-related functionality of the downlink channel and that is transmitted to the terminal.

The type of the terminal is used to indicate the repetition-related functionality of the downlink channel supported by the terminal, or to request downlink transmission that is corresponding to the repetition-related functionality of the downlink channel and that is transmitted to the terminal.

The frequency band in which the terminal operates is used to indicate the repetition-related functionality of the downlink channel supported by the terminal, or to request downlink transmission that is corresponding to the repetition-related functionality of the downlink channel and that is transmitted to the terminal.

The capability level of the terminal is used to indicate the repetition-related functionality of the downlink channel supported by the terminal, or to request downlink transmission that is corresponding to the repetition-related functionality of the downlink channel and that is transmitted to the terminal.

Optionally, the repetition-related functionality of the downlink channel includes at least one of the following:
repetition of the downlink channel;
extension of a reception window of the downlink channel;
allowance for the repetition of the downlink channel exceeding the reception window corresponding to the downlink channel;
extension of a timer corresponding to the downlink channel; and
allowance for the repetition of the downlink channel exceeding duration of the timer corresponding to the downlink channel.

Optionally, the reception window of the downlink channel includes at least one of the following: a random access response RAR window and a MsgB response window.

Alternatively, the timer corresponding to the downlink channel includes a contention resolution timer.

Optionally, the repetition of the downlink channel includes at least one of the following:
repetition of the downlink channel of a single transmission reception point TRP;
repetition of the downlink channel between multiple TRPs;
repetitions of the downlink channel based on available slots;
repetition of the downlink channel based on physical slots;
repetition of the downlink channel supporting the extension of the reception window of the downlink channel;
repetition of the downlink channel not supporting the extension of the reception window of the downlink channel;
repetitions of the downlink channel supporting the allowance for the repetition of the downlink channel exceeding the reception window corresponding to the downlink channel;
repetition of the downlink channel not supporting the allowance for the repetition of the downlink channel exceeding the reception window corresponding to the downlink channel;
repetition of the downlink channel supporting the extension of the timer corresponding to the downlink channel;
repetition of the downlink channel not supporting the extension of the timer corresponding to the downlink channel;
repetition of the downlink channel supporting the allowance for the repetition of the downlink channel exceeding duration of the timer corresponding to the downlink channel;
repetition of the downlink channel not supporting the allowance for the repetition of the downlink channel exceeding duration of the timer corresponding to the downlink channel;
intra-slot repetitions of the downlink channel;
inter-slot repetitions of the downlink channel;
intra-control resource set repetitions of the downlink channel;
inter-control resource set repetitions of the downlink channel;
intra-common search space CSS repetitions of the downlink channel;
inter-CSS repetition of the downlink channel;
intra-monitoring occasion repetition of the downlink channel;
inter-monitoring occasion repetitions of the downlink channel;
time-domain repetition of the downlink channel;
frequency-domain repetition of the downlink channel;
dynamic repetition of the downlink channel;
semi-static repetition of the downlink channel;
repetition of the downlink channel before radio resource control RRC connection establishment; and
repetition of the downlink channel before receiving dedicated PDSCH configuration.

Optionally, in a case that the repetition of the downlink channel includes multiple types of repetitions, the multiple types of repetitions are independent terminal capabilities, or the multiple types of repetitions are combined terminal capabilities.

Alternatively, in a case that the repetition of the downlink channel includes multiple types of repetitions, the multiple types of repetitions are indicated by a same target message, or the multiple types of repetitions are indicated by at least two target messages.

Optionally, the repetition of the downlink channel is defined at a granularity of the type of the terminal, or the repetition of the downlink channel is defined at a granularity of the priority of the terminal.

Optionally, a capability of the repetition of the downlink channel matches a target downlink channel repetition capability, and the target downlink channel repetition capability is a downlink channel repetition capability of the terminal after entering the connected state.

Optionally, in a case that the terminal supports the repetition of the downlink channel, the terminal supports the extension of the reception window of the downlink channel.

Alternatively, in a case that the terminal supports the repetition of the downlink channel, the terminal supports the allowance for the repetition of the downlink channel exceeding the reception window corresponding to the downlink channel.

Alternatively, in a case that the terminal supports the repetition of the downlink channel, the terminal supports the extension of the timer corresponding to the downlink channel.

Alternatively, in a case that the terminal supports the repetition of the downlink channel, the terminal supports the allowance for the repetition of the downlink channel exceeding duration of the timer corresponding to the downlink channel.

Optionally, in a case that the repetition-related functionality of the downlink channel includes multiple types of functions, the multiple types of functions are indicated by the same target message, or the multiple types of functions are indicated by at least two target messages.

Optionally, the transmitting, by a terminal, a target message includes:
transmitting, by the terminal, the target message under target conditions, the target conditions including at least one of the following:
a reference signal received power RSRP of a downlink signal is greater than or equal to a first threshold;
a reference signal received quality RSRQ of the downlink signal is greater than or equal to a second threshold;
an uplink channel corresponding to the downlink channel performs repetition, or the uplink channel corresponding to the downlink channel does not perform repetition;
a same repetition request condition is used for all or part of the channels of the downlink channel;
a RSRP threshold for all or part of the channels of the downlink channel is the same, or the RSRP threshold for all or part of the channels of the downlink channel is different;
and
a RSRQ threshold for all or part of the channels of the downlink channel is the same, or the RSRQ threshold for all or part of the channels of the downlink channel is different.

Optionally, the common PDSCH includes at least one of the following:
Msg2 PDSCH, MsgB PDSCH, and Msg4 PDSCH.

Alternatively, the common PDCCH includes at least one of the following:
SIB1 PDCCH, OSI PDCCH, Msg2 PDCCH, Msg4 PDCCH, MsgB PDCCH, Paging PDCCH, and PDCCH scheduling Msg3 retransmission.

Optionally, the apparatus further includes:
a receiving module, configured to, in a case that the terminal has not transmitted the target message, receive configuration information, the configuration information being used to configure repetition resources of the downlink channel.

In a case that the terminal supports the repetition-related functionality of the downlink channel, the terminal performs blind detection on the repetition resources and non-repetition resources of the downlink channel, or, in a case that the terminal does not support the repetition-related functionality of the downlink channel, the terminal performs blind detection on the non-repetition resources of the downlink channel.

The above message transmission apparatus can enhance the service performance of the terminal.

The message transmission apparatus in the embodiments of the present application may be an electronic device, for example, an electronic device having an operating system, or a component in an electronic device, such as an integrated circuit or a chip. For example, the electronic device may be a terminal or another device other than a terminal. Exemplarily, the terminal may include, but is not limited to, the types of terminals listed in the embodiments of the present application. Other devices may include servers, network attached storage (NAS), etc, which are not specifically limited in the embodiments of the present application.

The message transmission apparatus according to the embodiments of the present application can implement the processes implemented in the method embodiments illustrated in FIG. 2, and achieve the same technical effects. To avoid repetition, a detailed description is omitted herein.

Referring to FIG. 5, FIG. 5 is a structural diagram of a message receiving apparatus according to an embodiment of the present application. As shown in FIG. 5, the message receiving apparatus 500 includes:
a receiving module 501, configured to receive a target message transmitted by a terminal, the target message being used for at least one of the following:
indicating repetition-related functionality of a downlink channel supported by the terminal; and
requesting downlink transmission that is corresponding to the repetition-related functionality of the downlink channel and that is transmitted to the terminal.

The downlink channel includes at least one of the following:
a common physical downlink control channel PDCCH and a common physical downlink shared channel PDSCH.

Optionally, the common PDCCH includes at least one of the following:
a PDCCH to be transmitted to the terminal before entering a connected state; and
a PDCCH transmitted on common PDCCH resources.

Alternatively,
the common PDSCH includes:
a PDSCH to be transmitted to the terminal before entering the connected state.

Optionally, the target message includes at least one of the following:
a physical random access channel PRACH, Msg1, Msg3 PUSCH, MsgA, MsgA PUSCH, and a message transmitted by the terminal in the connected state.

Optionally, the PRACH is used for the indication/request through at least one of the following:
a time-domain resource of the PRACH, a frequency-domain resource of the PRACH, a configuration index of the PRACH, a sequence of the PRACH, a scrambling sequence of a sequence of the PRACH, a format of the PRACH, and whether the PRACH performs repetition.

Alternatively,
the MsgA PUSCH is used for the indication/request through at least one of the following:
information carried by the MsgA PUSCH, a time-domain resource of the MsgA PUSCH, a frequency-domain resource of the MsgA PUSCH, a demodulation reference signal DMRS resource of the MsgA PUSCH, a group in which the MsgA PUSCH is located, and whether the MsgA PUSCH performs repetition.

Alternatively,
the MsgA is used for the indication/request through at least one of the following:
a time-domain resource of the MsgA, a frequency-domain resource of the MsgA, and a DMRS resource of the MsgA.

Alternatively,
the Msg3 PUSCH is used for the indication/request through at least one of the following:
information carried by the Msg3 PUSCH, a time-domain resource of the Msg3 PUSCH, a frequency-domain resource of the Msg3 PUSCH, a DMRS resource of the Msg3 PUSCH, a payload size of the Msg3 PUSCH, and whether the Msg3 PUSCH performs repetition.

Alternatively,
the Msg1 is used to indicate the payload size of the Msg3 PUSCH or whether the Msg3 PUSCH performs repetition, where the payload size of the Msg3 PUSCH or whether the Msg3 PUSCH performs repetition is used for indication or request.

The indication includes: indicating the repetition-related functionality of the downlink channel supported by the terminal, and the request includes: requesting downlink transmission that is corresponding to the repetition-related functionality of the downlink channel and that is transmitted to the terminal.

Optionally, the target message is used to indicate at least one of the following:
a priority of the terminal, a type of the terminal, a frequency band in which the terminal operates, and a capability level of the terminal.

The priority of the terminal is used to indicate the repetition-related functionality of the downlink channel supported by the terminal, or to request downlink transmission that is corresponding to the repetition-related functionality of the downlink channel and that is transmitted to the terminal.

The type of the terminal is used to indicate the repetition-related functionality of the downlink channel supported by the terminal, or to request downlink transmission that is corresponding to the repetition-related functionality of the downlink channel and that is transmitted to the terminal.

The frequency band in which the terminal operates is used to indicate the repetition-related functionality of the downlink channel supported by the terminal, or to request downlink transmission that is corresponding to the repetition-related functionality of the downlink channel and that is transmitted to the terminal.

The capability level of the terminal is used to indicate the repetition-related functionality of the downlink channel supported by the terminal, or to request downlink transmission that is corresponding to the repetition-related functionality of the downlink channel and that is transmitted to the terminal.

Optionally, the repetition-related functionality of the downlink channel includes at least one of the following:
repetition of the downlink channel;
extension of a reception window of the downlink channel;
allowance for the repetition of the downlink channel exceeding the reception window corresponding to the downlink channel;
extension of a timer corresponding to the downlink channel; and
allowance for the repetition of the downlink channel exceeding duration of the timer corresponding to the downlink channel.

Optionally, the reception window of the downlink channel includes at least one of the following: an RAR window and a MsgB response window.

Alternatively, the timer corresponding to the downlink channel includes a contention resolution timer.

Optionally, the repetition of the downlink channel includes at least one of the following:
repetition of the downlink channel of a single transmission reception point TRP;
repetition of the downlink channel between multiple TRPs;
repetitions of the downlink channel based on available slots;
repetition of the downlink channel based on physical slots;
repetition of the downlink channel supporting the extension of the reception window of the downlink channel;
repetition of the downlink channel not supporting the extension of the reception window of the downlink channel;
repetitions of the downlink channel supporting the allowance for the repetition of the downlink channel exceeding the reception window corresponding to the downlink channel;
repetition of the downlink channel not supporting the allowance for the repetition of the downlink channel exceeding the reception window corresponding to the downlink channel;
repetition of the downlink channel supporting the extension of the timer corresponding to the downlink channel;
repetition of the downlink channel not supporting the extension of the timer corresponding to the downlink channel;
repetition of the downlink channel supporting the allowance for the repetition of the downlink channel exceeding duration of the timer corresponding to the downlink channel;
repetition of the downlink channel not supporting the allowance for the repetition of the downlink channel exceeding duration of the timer corresponding to the downlink channel;
intra-slot repetitions of the downlink channel;
inter-slot repetitions of the downlink channel;
intra-control resource set repetitions of the downlink channel;
inter-control resource set repetitions of the downlink channel;
intra-common search space CSS repetitions of the downlink channel;
inter-CSS repetition of the downlink channel;
intra-monitoring occasion repetition of the downlink channel;
inter-monitoring occasion repetitions of the downlink channel;
time-domain repetition of the downlink channel;
frequency-domain repetition of the downlink channel;
dynamic repetition of the downlink channel;
semi-static repetition of the downlink channel;
repetition of the downlink channel before radio resource control RRC connection establishment; and
repetition of the downlink channel before receiving dedicated PDSCH configuration.

Optionally, in a case that the repetition of the downlink channel includes multiple types of repetitions, the multiple types of repetitions are independent terminal capabilities, or the multiple types of repetitions are combined terminal capabilities.

Alternatively, in a case that the repetition of the downlink channel includes multiple types of repetitions, the multiple types of repetitions are indicated by a same target message, or the multiple types of repetitions are indicated by at least two target messages.

Optionally, the repetition of the downlink channel is defined at a granularity of the type of the terminal, or the repetition of the downlink channel is defined at a granularity of the priority of the terminal.

Optionally, a capability of the repetition of the downlink channel matches a target downlink channel repetition capability, and the target downlink channel repetition capability is a downlink channel repetition capability of the terminal after entering the connected state.

Optionally, in a case that the terminal supports the repetition of the downlink channel, it is determined that the terminal supports the extension of the reception window of the downlink channel.

Alternatively, in a case that the terminal supports the repetition of the downlink channel, it is determined that the terminal supports the allowance for the repetition of the downlink channel exceeding the reception window corresponding to the downlink channel.

Alternatively, in a case that the terminal supports the repetition of the downlink channel, it is determined that the terminal supports the extension of the timer corresponding to the downlink channel.

Alternatively, in a case that the terminal supports the repetition of the downlink channel, it is determined that the terminal supports the allowance for the repetition of the downlink channel exceeding duration of the timer corresponding to the downlink channel.

Optionally, in a case that the repetition-related functionality of the downlink channel includes multiple types of functions, the multiple types of functions are indicated by the same target message, or the multiple types of functions are indicated by at least two target messages.

Optionally, the common PDSCH includes at least one of the following:
Msg2 PDSCH, MsgB PDSCH, and Msg4 PDSCH.

Alternatively, the common PDCCH includes at least one of the following:
SIB1 PDCCH, OSI PDCCH, Msg2 PDCCH, Msg4 PDCCH, MsgB PDCCH, Paging PDCCH, and PDCCH scheduling Msg3 retransmission.

Optionally, the apparatus further includes:
a transmission module, configured to, in a case that the target message transmitted by the terminal has not been received, transmit configuration information to the terminal, the configuration information being used to configure repetition resources of the downlink channel.

The above message receiving apparatus can enhance the service performance of the terminal.

The message receiving apparatus in the embodiments of the present application may be an electronic device, for example, an electronic device having an operating system, or a component in an electronic device, such as an integrated circuit or a chip. The electronic device may be a terminal or a network-side device.

The message receiving apparatus according to the embodiments of the present application can implement the processes implemented in the method embodiments illustrated in FIG. 3 and achieving the same technical effects. To avoid repetition, a detailed description is omitted herein.

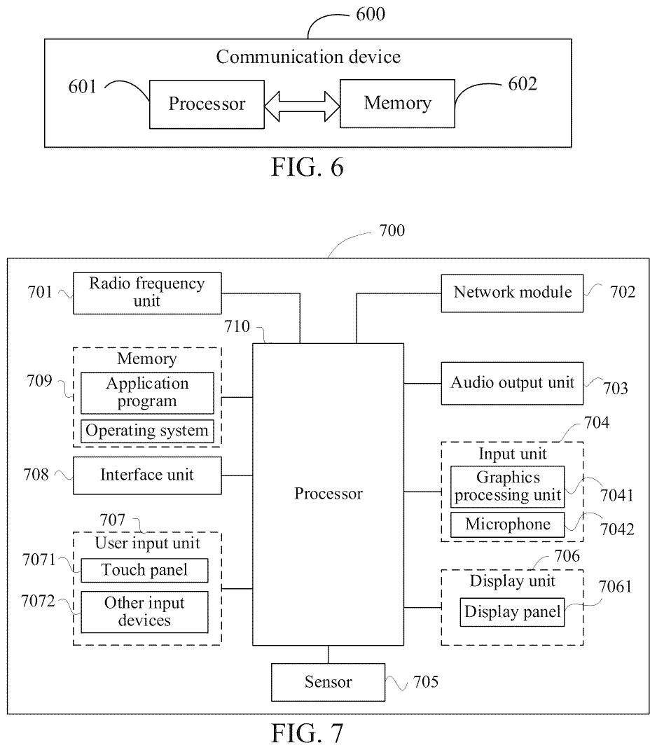

Optionally, as shown in FIG. 6, the embodiments of the present application further provide a communication device 600, which includes a processor 601 and a memory 602. The memory 602 has programs or instructions executable by the processor 601 stored therein. For example, when the communication device 600 is a terminal, the programs or instructions, when executed by the processor 601, implement steps of the above message transmission method embodiments and achieve the same technical effects. When the communication device 600 is a network-side device, the programs or instructions, when executed by the processor 601, implement steps of the above message receiving method embodiments, achieving the same technical effects. To avoid repetition, a detailed description is omitted herein.

The embodiments of the present application further provides a terminal including a processor and a communication interface, the communication interface being configured to transmit a target message used for at least one of the following: indicating repetition-related functionality of a downlink channel supported by the terminal; and requesting downlink transmission that is corresponding to the repetition-related functionality of the downlink channel and that is transmitted to the terminal, where the downlink channel includes at least one of the following: a common PDCCH and a common PDSCH.

As shown in FIG. 7, the terminal 700 includes, but is not limited to, at least part of the following components: a radio frequency unit 701, a network module 702, an audio output unit 703, an input unit 704, a sensor 705, a display unit 706, a user input unit 707, an interface unit 708, a memory 709, and a processor 710.

A person skilled in the art may understand that the terminal 700 may further include a power supply (e.g., a battery) configured to provide power to the components. The power supply can be logically connected to the processor 710 via a power management system, thereby enabling the management of charging, discharging, and power consumption through the power management system. A structure of the communication device shown in FIG. 7 constitutes no limitation on the communication device, and the communication device may include more or fewer components than those shown in the figure, or some components may be combined, or a different component deployment may be used, and details are omitted here.

It is to be understood that, in the embodiments of the present application, the input unit 704 may include a graphics processing unit (GPU) 7041 and a microphone 7042. The graphics processing unit 7041 processes image data of still images or videos captured by an image capture apparatus (such as a camera) in video capture mode or image capture mode. The display unit 706 may include a display panel 7061, which can be configured in the form of a liquid crystal display, an organic light-emitting diode, or the like. The user input unit 707 includes at least one of a touch panel 7071 and other input devices 7072. The touch panel 7071 is also referred to as a touchscreen. The touch panel 7071 may include two components: a touch detection apparatus and a touch controller. Other input devices 7072 may include, but are not limited to, a physical keyboard, function keys (e.g., volume control keys, power keys, etc.), a trackball, a mouse, or a joystick, which are not further described herein.

In the embodiments of the present application, the radio frequency unit 701 may transmit downlink data received from a network-side device to the processor 710 for processing. Additionally, the radio frequency unit 701 may transmit uplink data to the network-side device. Generally, the radio frequency unit 701 includes, but is not limited to, an antenna, an amplifier, a transceiver, a coupler, a low-noise amplifier, and a duplexer.

The memory 709 may be configured to store software programs or instructions, as well as various data. The memory 709 may mainly include a first storage area for storing programs or instructions and a second storage area for storing data. The first storage area may store an operating system, at least one application program or instruction required for a function (such as audio playback, image playback, etc.), and the like. In addition, the memory 709 may include a volatile memory or a non-volatile memory, or the memory 709 may include both the volatile memory and the non-volatile memory. The non-volatile memory may be a read-only memory (ROM), a programmable ROM (PROM), an erasable PROM (EPROM), an electrically EPROM (EEPROM), or flash memory. The volatile memory may include random access memory (RAM), static RAM (SRAM), dynamic RAM (DRAM), synchronous DRAM (SDRAM), double data rate SDRAM (DDRSDRAM), enhanced SDRAM (ESDRAM), Synch link DRAM (SLDRAM), or Direct Rambus RAM (DRRAM). The memory 709 in the embodiments of the present application includes, but is not limited to, the above types of memory and any other suitable types of memory.

The processor 710 may include one or more processing units. Optionally, the processor 710 integrates an application processor and a modem processor. The application processor mainly processes operations involving an operating system, a user interface, an application program, and the like. The modem processor mainly processes a wireless communication signal, and is, for example, a baseband processor. It can be understood that the above modem processor may not be integrated into the processor 710.

The radio frequency unit 701 is configured to transmit a target message, the target message being used for at least one of the following:
indicating repetition-related functionality of a downlink channel supported by the terminal; and
requesting downlink transmission that is corresponding to the repetition-related functionality of the downlink channel and that is transmitted to the terminal.

The downlink channel includes at least one of the following:
a common PDCCH and a common PDSCH.

Optionally, the common PDCCH includes at least one of the following:
a PDCCH to be received by the terminal before entering a connected state; and
a PDCCH transmitted on common PDCCH resources.

Alternatively,
the common PDSCH includes:
a PDSCH to be received by the terminal before entering the connected state.

Optionally, the target message includes at least one of the following:
PRACH, Msg1, Msg3 PUSCH, MsgA, MsgA PUSCH, and a message transmitted by the terminal in the connected state.

Optionally, the PRACH is used for the indication/request through at least one of the following:
a time-domain resource of the PRACH, a frequency-domain resource of the PRACH, a configuration index of the PRACH, a sequence of the PRACH, a scrambling sequence of a sequence of the PRACH, a format of the PRACH, and whether the PRACH performs repetition.

Alternatively,
the MsgA PUSCH is used for the indication/request through at least one of the following:
information carried by the MsgA PUSCH, a time-domain resource of the MsgA PUSCH, a frequency-domain resource of the MsgA PUSCH, a demodulation reference signal DMRS resource of the MsgA PUSCH, a group in which the MsgA PUSCH is located, and whether the MsgA PUSCH performs repetition.

Alternatively,
the MsgA is used for the indication/request through at least one of the following:
a time-domain resource of the MsgA, a frequency-domain resource of the MsgA, and a DMRS resource of the MsgA.

Alternatively,
the Msg3 PUSCH is used for the indication/request through at least one of the following:
information carried by the Msg3 PUSCH, a time-domain resource of the Msg3 PUSCH, a frequency-domain resource of the Msg3 PUSCH, a DMRS resource of the Msg3 PUSCH, a payload size of the Msg3 PUSCH, and whether the Msg3 PUSCH performs repetition.

Alternatively,
the Msg1 is used to indicate the payload size of the Msg3 PUSCH or whether the Msg3 PUSCH performs repetition, where the payload size of the Msg3 PUSCH or whether the Msg3 PUSCH performs repetition is used for indication or request.

The indication includes: indicating the repetition-related functionality of the downlink channel supported by the terminal, and the request includes: requesting downlink transmission that is corresponding to the repetition-related functionality of the downlink channel and that is transmitted to the terminal.

Optionally, the target message is used to indicate at least one of the following:
a priority of the terminal, a type of the terminal, a frequency band in which the terminal operates, and a capability level of the terminal.

The priority of the terminal is used to indicate the repetition-related functionality of the downlink channel supported by the terminal, or to request downlink transmission that is corresponding to the repetition-related functionality of the downlink channel and that is transmitted to the terminal.

The type of the terminal is used to indicate the repetition-related functionality of the downlink channel supported by the terminal, or to request downlink transmission that is corresponding to the repetition-related functionality of the downlink channel and that is transmitted to the terminal.

The frequency band in which the terminal operates is used to indicate the repetition-related functionality of the downlink channel supported by the terminal, or to request downlink transmission that is corresponding to the repetition-related functionality of the downlink channel and that is transmitted to the terminal.

The capability level of the terminal is used to indicate the repetition-related functionality of the downlink channel supported by the terminal, or to request downlink transmission that is corresponding to the repetition-related functionality of the downlink channel and that is transmitted to the terminal.

Optionally, the repetition-related functionality of the downlink channel includes at least one of the following:
repetition of the downlink channel;
extension of a reception window of the downlink channel;
allowance for the repetition of the downlink channel exceeding the reception window corresponding to the downlink channel;
extension of a timer corresponding to the downlink channel; and
allowance for the repetition of the downlink channel exceeding duration of the timer corresponding to the downlink channel.

Optionally, the reception window of the downlink channel includes at least one of the following: an RAR window and a MsgB response window.

Alternatively, the timer corresponding to the downlink channel includes a contention resolution timer.

Optionally, the repetition of the downlink channel includes at least one of the following:
repetition of the downlink channel of a single transmission reception point TRP;
repetition of the downlink channel between multiple TRPs;
repetitions of the downlink channel based on available slots;
repetition of the downlink channel based on physical slots;
repetition of the downlink channel supporting the extension of the reception window of the downlink channel;
repetition of the downlink channel not supporting the extension of the reception window of the downlink channel;
repetitions of the downlink channel supporting the allowance for the repetition of the downlink channel exceeding the reception window corresponding to the downlink channel;
repetition of the downlink channel not supporting the allowance for the repetition of the downlink channel exceeding the reception window corresponding to the downlink channel;
repetition of the downlink channel supporting the extension of the timer corresponding to the downlink channel;
repetition of the downlink channel not supporting the extension of the timer corresponding to the downlink channel;
repetition of the downlink channel supporting the allowance for the repetition of the downlink channel exceeding duration of the timer corresponding to the downlink channel;
repetition of the downlink channel not supporting the allowance for the repetition of the downlink channel exceeding duration of the timer corresponding to the downlink channel;
intra-slot repetitions of the downlink channel;
inter-slot repetitions of the downlink channel;
intra-control resource set repetitions of the downlink channel;
inter-control resource set repetitions of the downlink channel;
intra-common search space CSS repetitions of the downlink channel;
inter-CSS repetition of the downlink channel;
intra-monitoring occasion repetition of the downlink channel;
inter-monitoring occasion repetitions of the downlink channel;
time-domain repetition of the downlink channel;
frequency-domain repetition of the downlink channel;
dynamic repetition of the downlink channel;
semi-static repetition of the downlink channel;
repetition of the downlink channel before radio resource control RRC connection establishment; and
repetition of the downlink channel before receiving dedicated PDSCH configuration.

Optionally, in a case that the repetition of the downlink channel includes multiple types of repetitions, the multiple types of repetitions are independent terminal capabilities, or the multiple types of repetitions are combined terminal capabilities.

Alternatively, in a case that the repetition of the downlink channel includes multiple types of repetitions, the multiple types of repetitions are indicated by a same target message, or the multiple types of repetitions are indicated by at least two target messages.

Optionally, the repetition of the downlink channel is defined at a granularity of the type of the terminal, or the repetition of the downlink channel is defined at a granularity of the priority of the terminal.

Optionally, a capability of the repetition of the downlink channel matches a target downlink channel repetition capability, and the target downlink channel repetition capability is a downlink channel repetition capability of the terminal after entering the connected state.

Optionally, in a case that the terminal supports the repetition of the downlink channel, the terminal supports the extension of the reception window of the downlink channel.

Alternatively, in a case that the terminal supports the repetition of the downlink channel, the terminal supports the allowance for the repetition of the downlink channel exceeding the reception window corresponding to the downlink channel.

Alternatively, in a case that the terminal supports the repetition of the downlink channel, the terminal supports the extension of the timer corresponding to the downlink channel.

Alternatively, in a case that the terminal supports the repetition of the downlink channel, the terminal supports the allowance for the repetition of the downlink channel exceeding duration of the timer corresponding to the downlink channel.

Optionally, in a case that the repetition-related functionality of the downlink channel includes multiple types of functions, the multiple types of functions are indicated by the same target message, or the multiple types of functions are indicated by at least two target messages.

Optionally, the transmitting, by a terminal, a target message includes:
transmitting, by the terminal, the target message under target conditions, the target conditions including at least one of the following:
a reference signal received power RSRP of a downlink signal is greater than or equal to a first threshold;
a reference signal received quality RSRQ of the downlink signal is greater than or equal to a second threshold;
an uplink channel corresponding to the downlink channel performs repetition, or the uplink channel corresponding to the downlink channel does not perform repetition;
a same repetition request condition is used for all or part of the channels of the downlink channel;
a RSRP threshold for all or part of the channels of the downlink channel is the same, or the RSRP threshold for all or part of the channels of the downlink channel is different; and
a RSRQ threshold for all or part of the channels of the downlink channel is the same, or the RSRQ threshold for all or part of the channels of the downlink channel is different.

Optionally, the common PDSCH includes at least one of the following:
Msg2 PDSCH, MsgB PDSCH, and Msg4 PDSCH.

Alternatively, the common PDCCH includes at least one of the following:
SIB1 PDCCH, OSI PDCCH, Msg2 PDCCH, Msg4 PDCCH, MsgB PDCCH, Paging PDCCH, and PDCCH scheduling Msg3 retransmission.

Optionally, the radio frequency unit 701 is further configured to:
in a case that the terminal has not transmitted the target message, receive configuration information, the configuration information being used to configure repetition resources of the downlink channel.

In a case that the terminal supports the repetition-related functionality of the downlink channel, the terminal performs blind detection on the repetition resources and non-repetition resources of the downlink channel, or, in a case that the terminal does not support the repetition-related functionality of the downlink channel, the terminal performs blind detection on the non-repetition resources of the downlink channel.

The above terminal can enhance the service performance of the terminal.

It can be understood that the implementation processes of the implementations described in this embodiment may refer to the related description of the above method embodiments, and can achieve the same or equivalent technical effects. To avoid repetition, a detailed description is omitted herein.

The embodiments of the present application further provide a network-side device, including a processor and a communication interface, the communication interface being configured to receive a target message transmitted by a terminal, and the target message being used for at least one of the following: indicating repetition-related functionality of a downlink channel supported by the terminal; and requesting downlink transmission that is corresponding to the repetition-related functionality of the downlink channel and that is transmitted to the terminal, where the downlink channel includes at least one of the following: a common PDCCH and a common PDSCH.

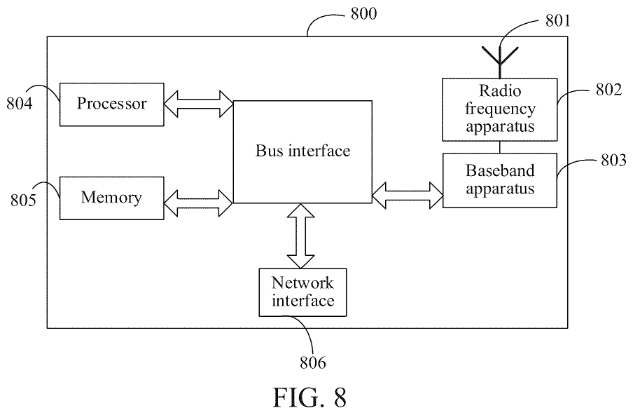

As shown in FIG. 8, the network-side device 800 includes an antenna 801, a radio frequency apparatus 802, a baseband apparatus 803, a processor 804, and a memory 805. The antenna 801 is connected to the radio frequency apparatus 802. In the upstream direction, the radio frequency apparatus 802 receives information through the antenna 801 and transmits the received information to the baseband apparatus 803 for processing. In the downlink direction, the baseband apparatus 803 processes the information to be transmitted and transmits the information to the radio frequency apparatus 802, and the radio frequency apparatus 802 processes the received information and transmits the information via the antenna 801.

The method executed by the wireless access network device in the above embodiments can be implemented in the baseband apparatus 803, and the baseband apparatus 803 includes a baseband processor.

The baseband apparatus 803 may, for example, include at least one baseband board, and the baseband board is provided with multiple chips, as shown in FIG. 8. One of the chips, for example, is the baseband processor, which is connected to the memory 805 via a bus interface to call programs in the memory 805 and execute the network device operations shown in the method embodiments above.

The wireless access network device may include a network interface 806, which may be, for example, a common public radio interface (CPRI).

In some implementations, the network-side device 800 of the embodiments of the present application further includes instructions or programs stored in the memory 805 and executable on the processor 804. The processor 804 calls the instructions or programs from the memory 805 to execute the methods performed by the modules shown in FIG. 5, achieving the same technical effects. To avoid repetition, these details are not restated here.

The radio frequency apparatus 802 is configured to receive a target message transmitted by the terminal, the target message being used for at least one of the following:
indicating repetition-related functionality of a downlink channel supported by the terminal; and
requesting downlink transmission that is corresponding to the repetition-related functionality of the downlink channel and that is transmitted to the terminal.

The downlink channel includes at least one of the following:
a common physical downlink control channel PDCCH and a common physical downlink shared channel PDSCH.

Optionally, the common PDCCH includes at least one of the following:
a PDCCH to be transmitted to the terminal before entering a connected state; and
a PDCCH transmitted on common PDCCH resources.

Alternatively,
the common PDSCH includes:
a PDSCH to be transmitted to the terminal before entering the connected state.

Optionally, the target message includes at least one of the following:
a physical random access channel PRACH, Msg1, Msg3 PUSCH, MsgA, MsgA PUSCH, and a message transmitted by the terminal in the connected state.

Optionally, the PRACH is used for the indication/request through at least one of the following:
a time-domain resource of the PRACH, a frequency-domain resource of the PRACH, a configuration index of the PRACH, a sequence of the PRACH, a scrambling sequence of a sequence of the PRACH, a format of the PRACH, and whether the PRACH performs repetition.

Alternatively,
the MsgA PUSCH is used for the indication/request through at least one of the following:
information carried by the MsgA PUSCH, a time-domain resource of the MsgA PUSCH, a frequency-domain resource of the MsgA PUSCH, a demodulation reference signal DMRS resource of the MsgA PUSCH, a group in which the MsgA PUSCH is located, and whether the MsgA PUSCH performs repetition.

Alternatively,
the MsgA is used for the indication/request through at least one of the following:
a time-domain resource of the MsgA, a frequency-domain resource of the MsgA, and a DMRS resource of the MsgA.

Alternatively,
the Msg3 PUSCH is used for the indication/request through at least one of the following:
information carried by the Msg3 PUSCH, a time-domain resource of the Msg3 PUSCH, a frequency-domain resource of the Msg3 PUSCH, a DMRS resource of the Msg3 PUSCH, a payload size of the Msg3 PUSCH, and whether the Msg3 PUSCH performs repetition.

Alternatively,
the Msg1 is used to indicate the payload size of the Msg3 PUSCH or whether the Msg3 PUSCH performs repetition, where the payload size of the Msg3 PUSCH or whether the Msg3 PUSCH performs repetition is used for indication or request.

The indication includes: indicating the repetition-related functionality of the downlink channel supported by the terminal, and the request includes: requesting downlink transmission that is corresponding to the repetition-related functionality of the downlink channel and that is transmitted to the terminal.

Optionally, the target message is used to indicate at least one of the following:
a priority of the terminal, a type of the terminal, a frequency band in which the terminal operates, and a capability level of the terminal.

The priority of the terminal is used to indicate the repetition-related functionality of the downlink channel supported by the terminal, or to request downlink transmission that is corresponding to the repetition-related functionality of the downlink channel and that is transmitted to the terminal.

The type of the terminal is used to indicate the repetition-related functionality of the downlink channel supported by the terminal, or to request downlink transmission that is corresponding to the repetition-related functionality of the downlink channel and that is transmitted to the terminal.

The frequency band in which the terminal operates is used to indicate the repetition-related functionality of the downlink channel supported by the terminal, or to request downlink transmission that is corresponding to the repetition-related functionality of the downlink channel and that is transmitted to the terminal.

The capability level of the terminal is used to indicate the repetition-related functionality of the downlink channel supported by the terminal, or to request downlink transmission that is corresponding to the repetition-related functionality of the downlink channel and that is transmitted to the terminal.

Optionally, the repetition-related functionality of the downlink channel includes at least one of the following:
repetition of the downlink channel;
extension of a reception window of the downlink channel;
allowance for the repetition of the downlink channel exceeding the reception window corresponding to the downlink channel;
extension of a timer corresponding to the downlink channel; and
allowance for the repetition of the downlink channel exceeding duration of the timer corresponding to the downlink channel.

Optionally, the reception window of the downlink channel includes at least one of the following: an RAR window and a MsgB response window.

Alternatively, the timer corresponding to the downlink channel includes a contention resolution timer.

Optionally, the repetition of the downlink channel includes at least one of the following:
repetition of the downlink channel of a single transmission reception point TRP;
repetition of the downlink channel between multiple TRPs;
repetitions of the downlink channel based on available slots;
repetition of the downlink channel based on physical slots;
repetition of the downlink channel supporting the extension of the reception window of the downlink channel;
repetition of the downlink channel not supporting the extension of the reception window of the downlink channel;
repetitions of the downlink channel supporting the allowance for the repetition of the downlink channel exceeding the reception window corresponding to the downlink channel;
repetition of the downlink channel not supporting the allowance for the repetition of the downlink channel exceeding the reception window corresponding to the downlink channel;
repetition of the downlink channel supporting the extension of the timer corresponding to the downlink channel;
repetition of the downlink channel not supporting the extension of the timer corresponding to the downlink channel;
repetition of the downlink channel supporting the allowance for the repetition of the downlink channel exceeding duration of the timer corresponding to the downlink channel;
repetition of the downlink channel not supporting the allowance for the repetition of the downlink channel exceeding duration of the timer corresponding to the downlink channel;
intra-slot repetitions of the downlink channel;
inter-slot repetitions of the downlink channel;
intra-control resource set repetitions of the downlink channel;
inter-control resource set repetitions of the downlink channel;
intra-common search space CSS repetitions of the downlink channel;
inter-CSS repetition of the downlink channel;
intra-monitoring occasion repetition of the downlink channel;
inter-monitoring occasion repetitions of the downlink channel;
time-domain repetition of the downlink channel;
frequency-domain repetition of the downlink channel;
dynamic repetition of the downlink channel;
semi-static repetition of the downlink channel;
repetition of the downlink channel before radio resource control RRC connection establishment; and
repetition of the downlink channel before receiving dedicated PDSCH configuration.

Optionally, in a case that the repetition of the downlink channel includes multiple types of repetitions, the multiple types of repetitions are independent terminal capabilities, or the multiple types of repetitions are combined terminal capabilities.

Alternatively, in a case that the repetition of the downlink channel includes multiple types of repetitions, the multiple types of repetitions are indicated by a same target message, or the multiple types of repetitions are indicated by at least two target messages.

Optionally, the repetition of the downlink channel is defined at a granularity of the type of the terminal, or the repetition of the downlink channel is defined at a granularity of the priority of the terminal.

Optionally, a capability of the repetition of the downlink channel matches a target downlink channel repetition capability, and the target downlink channel repetition capability is a downlink channel repetition capability of the terminal after entering the connected state.

Optionally, in a case that the terminal supports the repetition of the downlink channel, it is determined that the terminal supports the extension of the reception window of the downlink channel.

Alternatively, in a case that the terminal supports the repetition of the downlink channel, it is determined that the terminal supports the allowance for the repetition of the downlink channel exceeding the reception window corresponding to the downlink channel.

Alternatively, in a case that the terminal supports the repetition of the downlink channel, it is determined that the terminal supports the extension of the timer corresponding to the downlink channel.

Alternatively, in a case that the terminal supports the repetition of the downlink channel, it is determined that the terminal supports the allowance for the repetition of the downlink channel exceeding duration of the timer corresponding to the downlink channel.

Optionally, in a case that the repetition-related functionality of the downlink channel includes multiple types of functions, the multiple types of functions are indicated by the same target message, or the multiple types of functions are indicated by at least two target messages.

Optionally, the common PDSCH includes at least one of the following:
Msg2 PDSCH, MsgB PDSCH, and Msg4 PDSCH.

Alternatively, the common PDCCH includes at least one of the following:
SIB1 PDCCH, OSI PDCCH, Msg2 PDCCH, Msg4 PDCCH, MsgB PDCCH, Paging PDCCH, and PDCCH scheduling Msg3 retransmission.

Optionally, the radio frequency apparatus 802 is further configured to:
in a case that the target message transmitted by the terminal has not been received, transmit configuration information to the terminal, the configuration information being used to configure repetition resources of the downlink channel.

The above network-side device can enhance the service performance of the terminal.

The embodiments of the present application further provide a readable storage medium having programs or instructions stored therein. The programs or instructions, when executed by a processor, implement the processes of the above message transmission method and message receiving method embodiments and achieve the same technical effects. To avoid repetition, a detailed description is omitted herein.

The processor is a processor of the terminal described in the above embodiments. The readable storage medium includes a computer-readable storage medium, such as a computer read-only memory ROM, a random access memory RAM, a magnetic disk, or an optical disk. In some examples, the readable storage medium may be a non-transitory readable storage medium.

The embodiments of the present application further provide a chip including a processor and a communication interface, the communication interface coupled to the processor, where the processor is configured to execute programs or instructions to implement the processes of the above message transmission method and message receiving method embodiments and achieve the same technical effects. To avoid repetition, a detailed description is omitted herein.

It is to be understood that the chip mentioned in the embodiments of the present application may be referred to as a system-on-chip, a system chip, a chip system, or an on-chip system, and the like.

The embodiments of the present application further provide a computer program or computer program product, which is stored on a storage medium and executed by at least one processor to implement the processes of the above message transmission method and message receiving method embodiments and achieve the same technical effects. To avoid repetition, a detailed description is omitted herein.

The embodiments of the present application further provide a wireless communication system including a terminal and a network-side device, the terminal being configured to perform steps of the message transmission method according to the embodiments of the present application, and the network-side device being configured to perform steps of the message receiving method according to the embodiments of the present application.

It is to be noted that, as used herein, the terms “include”, “comprise”, and any of other variants are intended to encompass non-exclusive inclusion, such that a process, method, article, or apparatus that includes a series of elements not only includes those elements but also may include other elements not explicitly listed, or elements inherent to such a process, method, article, or apparatus. In the absence of further limitations, an element defined by the statement “including one . . . ” does not exclude the presence of additional identical elements in a process, method, article, or apparatus that includes the element. In addition, it is to be noted that the scope of the method and apparatus in implementations of the present application is not limited to performing functions in the order shown or discussed. Functions may be performed substantially simultaneously or in an order opposite to that described. For example, the method described may be executed in an order different from that illustrated, and various steps may be added, omitted, or combined. Additionally, features described in reference to certain examples may be combined in other examples.

From the description of the above implementations, a person skilled in the art can clearly understand that the methods of the above embodiments can be implemented by a computer software product together with a necessary general-purpose hardware platform, or, alternatively, entirely by hardware. The computer software product is stored in a storage medium (such as ROM, RAM, magnetic disk, optical disk, etc.) and includes multiple instructions configured to cause a terminal or a network-side device to perform the methods described in the embodiments of the present application.

The embodiments of the present application have been described above with reference to the drawings. However, the present application is not limited to the specific implementations described above. The above specific implementations are illustrative rather than restrictive.

What is claimed is:

1. A message transmission method, comprising:
transmitting, by a terminal, a target message, the target message being used for at least one of the following:
indicating repetition-related functionality of a downlink channel supported by the terminal; or
requesting downlink transmission that is corresponding to the repetition-related functionality of the downlink channel and that is transmitted to the terminal,
wherein the downlink channel comprises at least one of the following:
a common physical downlink control channel (PDCCH) or a common physical downlink shared channel (PDSCH).

2. The method according to claim 1, wherein the common PDCCH comprises at least one of the following:
a PDCCH to be received by the terminal before entering a connected state; or
a PDCCH transmitted on common PDCCH resources;
or
the common PDSCH comprises:
a PDSCH to be received by the terminal before entering the connected state.

3. The method according to claim 1, wherein the target message comprises at least one of the following:
a physical random access channel (PRACH), Message 1 (Msg1), Message 3 (Msg3) PUSCH, Message A (MsgA), MsgA PUSCH, or a message transmitted by the terminal in the connected state.

4. The method according to claim 3, wherein the PRACH is used for the indication/request through at least one of the following:
a time-domain resource of the PRACH, a frequency-domain resource of the PRACH, a configuration index of the PRACH, a sequence of the PRACH, a scrambling sequence of a sequence of the PRACH, a format of the PRACH, or whether the PRACH performs repetition;
or
the MsgA PUSCH is used for the indication/request through at least one of the following:
information carried by the MsgA PUSCH, a time-domain resource of the MsgA PUSCH, a frequency-domain resource of the MsgA PUSCH, a demodulation reference signal (DMRS) resource of the MsgA PUSCH, a group in which the MsgA PUSCH is located, or whether the MsgA PUSCH performs repetition;
or
the MsgA is used for the indication/request through at least one of the following:
a time-domain resource of the MsgA, a frequency-domain resource of the MsgA, or a DMRS resource of the MsgA;
or
the Msg3 PUSCH is used for the indication/request through at least one of the following:
information carried by the Msg3 PUSCH, a time-domain resource of the Msg3 PUSCH, a frequency-domain resource of the Msg3 PUSCH, a DMRS resource of the Msg3 PUSCH, a payload size of the Msg3 PUSCH, or whether the Msg3 PUSCH performs repetition;
or
the Msg1 is used to indicate the payload size of the Msg3 PUSCH or whether the Msg3 PUSCH performs repetition, wherein the payload size of the Msg3 PUSCH or whether the Msg3 PUSCH performs repetition is used for indication or request; and
wherein the indication comprises: indicating the repetition-related functionality of the downlink channel supported by the terminal, and the request comprises: requesting downlink transmission that is corresponding to the repetition-related functionality of the downlink channel and that is transmitted to the terminal.

5. The method according to claim 1, wherein the target message is used to indicate at least one of the following:
a priority of the terminal, a type of the terminal, a frequency band in which the terminal operates, or a capability level of the terminal, wherein
the priority of the terminal is used to indicate the repetition-related functionality of the downlink channel supported by the terminal, or to request downlink transmission that is corresponding to the repetition-related functionality of the downlink channel and that is transmitted to the terminal;
the type of the terminal is used to indicate the repetition-related functionality of the downlink channel supported by the terminal, or to request downlink transmission that is corresponding to the repetition-related functionality of the downlink channel and that is transmitted to the terminal;
the frequency band in which the terminal operates is used to indicate the repetition-related functionality of the downlink channel supported by the terminal, or to request downlink transmission that is corresponding to the repetition-related functionality of the downlink channel and that is transmitted to the terminal; and
the capability level of the terminal is used to indicate the repetition-related functionality of the downlink channel supported by the terminal, or to request downlink transmission that is corresponding to the repetition-related functionality of the downlink channel and that is transmitted to the terminal.

6. The method according to claim 1, wherein the repetition-related functionality of the downlink channel comprises at least one of the following:
repetition of the downlink channel;
extension of a reception window of the downlink channel;
allowance for the repetition of the downlink channel exceeding the reception window corresponding to the downlink channel;
extension of a timer corresponding to the downlink channel; or
allowance for the repetition of the downlink channel exceeding duration of the timer corresponding to the downlink channel.

7. The method according to claim 6, wherein the reception window of the downlink channel comprises at least one of the following: a random access response (RAR) window or a Message B (MsgB) response window; or
the timer corresponding to the downlink channel comprises: a contention resolution timer.

8. The method according to claim 6, wherein the repetition of the downlink channel comprises at least one of the following:
repetition of the downlink channel of a single transmission reception point (TRP);
repetition of the downlink channel between multiple TRPs;
repetitions of the downlink channel based on available slots;
repetition of the downlink channel based on physical slots;
repetition of the downlink channel supporting the extension of the reception window of the downlink channel;
repetition of the downlink channel not supporting the extension of the reception window of the downlink channel;
repetitions of the downlink channel supporting the allowance for the repetition of the downlink channel exceeding the reception window corresponding to the downlink channel;
repetition of the downlink channel not supporting the allowance for the repetition of the downlink channel exceeding the reception window corresponding to the downlink channel;
repetition of the downlink channel supporting the extension of the timer corresponding to the downlink channel;
repetition of the downlink channel not supporting the extension of the timer corresponding to the downlink channel;
repetition of the downlink channel supporting the allowance for the repetition of the downlink channel exceeding duration of the timer corresponding to the downlink channel;
repetition of the downlink channel not supporting the allowance for the repetition of the downlink channel exceeding duration of the timer corresponding to the downlink channel;
intra-slot repetitions of the downlink channel;
inter-slot repetitions of the downlink channel;
intra-control resource set repetitions of the downlink channel;
inter-control resource set repetitions of the downlink channel;
intra-common search space (CSS) repetitions of the downlink channel;
inter-CSS repetition of the downlink channel;
intra-monitoring occasion repetition of the downlink channel;
inter-monitoring occasion repetitions of the downlink channel;
time-domain repetition of the downlink channel;
frequency-domain repetition of the downlink channel;
dynamic repetition of the downlink channel;
semi-static repetition of the downlink channel;
repetition of the downlink channel before radio resource control (RRC) connection establishment; or
repetition of the downlink channel before receiving dedicated PDSCH configuration.

9. The method according to claim 8, wherein in a case that the repetition of the downlink channel comprises multiple types of repetitions, the multiple types of repetitions are independent terminal capabilities, or the multiple types of repetitions are combined terminal capabilities; or
in a case that the repetition of the downlink channel comprises multiple types of repetitions, the multiple types of repetitions are indicated by a same target message, or the multiple types of repetitions are indicated by at least two target messages.

10. The method according to claim 6, wherein the repetition of the downlink channel is defined at a granularity of the type of the terminal, or the repetition of the downlink channel is defined at a granularity of the priority of the terminal;
or,
wherein a capability of the repetition of the downlink channel matches a target downlink channel repetition capability, and the target downlink channel repetition capability is a downlink channel repetition capability of the terminal after entering the connected state.

11. The method according to claim 1, wherein the transmitting, by a terminal, a target message comprises:
transmitting, by the terminal, the target message under target conditions, the target conditions comprising at least one of the following:
a reference signal received power (RSRP) of a downlink signal is greater than or equal to a first threshold;
a reference signal received quality (RSRQ) of the downlink signal is greater than or equal to a second threshold;
an uplink channel corresponding to the downlink channel performs repetition, or the uplink channel corresponding to the downlink channel does not perform repetition;
a same repetition request condition is used for all or part of the channels of the downlink channel;
a RSRP threshold for all or part of the channels of the downlink channel is the same, or the RSRP threshold for all or part of the channels of the downlink channel is different; or
a RSRQ threshold for all or part of the channels of the downlink channel is the same, or the RSRQ threshold for all or part of the channels of the downlink channel is different.

12. A message receiving method, comprising:
receiving, by a network-side device, a target message transmitted by a terminal, the target message being used for at least one of the following:
indicating repetition-related functionality of a downlink channel supported by the terminal; or
requesting downlink transmission that is corresponding to the repetition-related functionality of the downlink channel and that is transmitted to the terminal,
wherein the downlink channel comprises at least one of the following:
a common physical downlink control channel (PDCCH) or a common physical downlink shared channel (PDSCH).

13. The method according to claim 12, wherein the common PDCCH comprises at least one of the following:
a PDCCH to be transmitted to the terminal before entering a connected state; or
a PDCCH transmitted on common PDCCH resources;
or
the common PDSCH comprises:
a PDSCH to be transmitted to the terminal before entering the connected state.

14. The method according to claim 12, wherein the target message comprises at least one of the following:
a physical random access channel (PRACH), Message 1 (Msg1), Message 3 (Msg3) PUSCH, Message A (MsgA), MsgA PUSCH, or a message transmitted by the terminal in the connected state.

15. The method according to claim 14, wherein the PRACH is used for the indication/request through at least one of the following:
a time-domain resource of the PRACH, a frequency-domain resource of the PRACH, a configuration index of the PRACH, a sequence of the PRACH, a scrambling sequence of a sequence of the PRACH, a format of the PRACH, or whether the PRACH performs repetition;
or
the MsgA PUSCH is used for the indication/request through at least one of the following:
information carried by the MsgA PUSCH, a time-domain resource of the MsgA PUSCH, a frequency-domain resource of the MsgA PUSCH, a demodulation reference signal (DMRS) resource of the MsgA PUSCH, a group in which the MsgA PUSCH is located, or whether the MsgA PUSCH performs repetition;
or
the MsgA is used for the indication/request through at least one of the following:
a time-domain resource of the MsgA, a frequency-domain resource of the MsgA, or a DMRS resource of the MsgA;
or
the Msg3 PUSCH is used for the indication/request through at least one of the following:
information carried by the Msg3 PUSCH, a time-domain resource of the Msg3 PUSCH, a frequency-domain resource of the Msg3 PUSCH, a DMRS resource of the Msg3 PUSCH, a payload size of the Msg3 PUSCH, or whether the Msg3 PUSCH performs repetition; or
the Msg1 is used to indicate the payload size of the Msg3 PUSCH or whether the Msg3 PUSCH performs repetition, wherein the payload size of the Msg3 PUSCH or whether the Msg3 PUSCH performs repetition is used for indication or request; and
wherein the indication comprises: indicating the repetition-related functionality of the downlink channel supported by the terminal, and the request comprises: requesting downlink transmission that is corresponding to the repetition-related functionality of the downlink channel and that is transmitted to the terminal.

16. The method according to claim 12, wherein the target message is used to indicate at least one of the following:
a priority of the terminal, a type of the terminal, a frequency band in which the terminal operates, or a capability level of the terminal, wherein
the priority of the terminal is used to indicate the repetition-related functionality of the downlink channel supported by the terminal, or to request downlink transmission that is corresponding to the repetition-related functionality of the downlink channel and that is transmitted to the terminal;
the type of the terminal is used to indicate the repetition-related functionality of the downlink channel supported by the terminal, or to request downlink transmission that is corresponding to the repetition-related functionality of the downlink channel and that is transmitted to the terminal;
the frequency band in which the terminal operates is used to indicate the repetition-related functionality of the downlink channel supported by the terminal, or to request downlink transmission that is corresponding to the repetition-related functionality of the downlink channel and that is transmitted to the terminal; and
the capability level of the terminal is used to indicate the repetition-related functionality of the downlink channel supported by the terminal, or to request downlink transmission that is corresponding to the repetition-related functionality of the downlink channel and that is transmitted to the terminal.

17. A terminal comprising a processor and a memory, the memory storing programs or instructions executable by the processor, wherein the programs or instructions, when executed by the processor, cause the terminal to perform:
transmitting a target message, the target message being used for at least one of the following:
indicating repetition-related functionality of a downlink channel supported by the terminal; or
requesting downlink transmission that is corresponding to the repetition-related functionality of the downlink channel and that is transmitted to the terminal,
wherein the downlink channel comprises at least one of the following:
a common physical downlink control channel (PDCCH) or a common physical downlink shared channel (PDSCH).

18. The terminal according to claim 17, wherein the common PDCCH comprises at least one of the following:
a PDCCH to be received by the terminal before entering a connected state; or
a PDCCH transmitted on common PDCCH resources;
or
the common PDSCH comprises:
a PDSCH to be received by the terminal before entering the connected state.

19. The terminal according to claim 17, wherein the target message comprises at least one of the following:
a physical random access channel (PRACH), Message 1 (Msg1), Message 3 (Msg3) PUSCH, Message A (MsgA), MsgA PUSCH, or a message transmitted by the terminal in the connected state.

20. A network-side device comprising a processor and a memory, the memory storing programs or instructions executable by the processor, and the programs or instructions, when executed by the processor, implementing steps of the message receiving method according to claim 12.
